(19) United States
(12) Patent Application Publication
(10) Pub. No.: US 2026/0270138 A1
(43) Pub. Date: Sep. 10, 2026

(54) CONTEXT-AWARE, ARTIFICIAL INTELLIGENCE-DRIVEN NETWORK DIAGNOSTICS AND TROUBLESHOOTING

(71) Applicant: Cisco Technology, Inc., San Jose, CA (US)

(72) Inventors: Srinivas Pitta, Milpitas, CA (US); Anand Singh, Milpitas, CA (US); Praveen Parthasarathy Iyengar, Milpitas, CA (US); Nagabhushan Bangalore Nanjaiah, Los Gatos, CA (US); Srinivas Yadam, Milpitas, CA (US); Prasanna Dharama Muruganandan, Milpitas, CA (US); Sharvari Komajwar, Vancouver (CA); Visweswara Rao Polisetti, Milpitas, CA (US); Sathish Reddy Revuri, Milpitas, CA (US); Ramabhakta Mahaveer Jinka, Milpitas, CA (US)

(21) Appl. No.: 19/074,032

(22) Filed: Mar. 7, 2025

(51) Int. Cl. H04L 41/0631; G06F 40/205; H04L 41/069; H04L 41/12; H04L 41/16; H04L 41/22

(52) U.S. Cl. CPC H04L 41/065; G06F 40/205; H04L 41/069; H04L 41/12; H04L 41/16; H04L 41/22

(57) ABSTRACT

Systems, devices, and methods for context-aware, Artificial Intelligence (AI)-driven Network Diagnostics and Troubleshooting (AINDT) are provided. An AINDT system receives a user input indicative of a network issue. The user input includes first logs associated with network devices. For an unclassified network issue, the AINDT system determines a network topology from at least one diagnostic context derived based on the user input, extracts log data from second logs based on the user input, the network topology, or configurable criteria, and identifies a root cause of the issue therefrom. For a classified network issue, the AINDT system runs the user input through a filter pipeline to derive at least one diagnostic context, augments a prompt template based on the diagnostic context(s), and identifies a root cause of the issue based on the prompt template. The AINDT system generates at least one recommendation based on the root cause to address the issue.

The present disclosure relates to network management. More particularly, the present disclosure relates to context-aware, artificial intelligence-driven network diagnostics and troubleshooting.

### BACKGROUND

With the exponential growth of digital technologies and increasing dependence on networks, there is a growing need for robust network management and ensuring proper functioning, performance, security, reliability, and optimization of the networks. As network environments increase in size and complexity, network providers may face large volumes of network events, for example, device events, data traffic, network incidents, security events, messages, alerts, or the like each day. These large volumes of network events can create complex issues that require thorough diagnostics and troubleshooting to identify root causes, ensure optimal performance, and prevent disruptions. Network managers including, for example, network engineers, developers, technicians, quality assurance teams, technical assistance centers, escalation teams, partners, or the like may rely on logs generated by multiple network devices and systems such as switches, routers, servers, or the like, to diagnose and troubleshoot issues associated with the networks, hereinafter referred to as “network issues.” However, identifying specific problems within these logs can be complex, difficult, time-consuming, and challenging. For example, the sheer volume of the logs generated in modern networks may make manual log analysis impractical. Moreover, diverse log formats, varied characters of network log data, and complex data structures or network structures may further complicate the process of log analysis. Real-time log analysis may be required to address urgent network issues based on network topologies. The lack of standardization in logging practices across network devices and organizations may add to the complexity, hindering log analysis and troubleshooting.

Further, while similar network issues may have been encountered already, manual cross-referencing of historical data which may include comparing incoming logs with historical bugs and patterns manually may be a labor-intensive process. Further, recurring network issues may require skilled network managers to identify patterns or sequences in the logs, as conventional systems may not automatically correlate the logs with known network issues, resulting in inadequate patent recognition. Furthermore, features such as Virtual Port Channel (VPC), Ethernet Virtual Private Network (EVPN)-Virtual Extensible Local Area Network (VXLAN), or the like may need an analysis of logs that are synchronized across multiple network devices, adding further complexity to log analysis. Additionally, conventional methods may face challenges with scalability and efficiency when analyzing large, distributed logs across multiple network devices. The limited availability of skilled personnel to interpret and analyze extensive log data may hinder the identification of root causes of the network issues. Experts may often possess knowledge confined to specific components, thereby requiring coordination and collaboration with other experts to reach comprehensive conclusions. This siloed approach may slow down the problem-solving process and delay resolution of the network issues. Further, integrating the log analysis with automation tools may further complicate the process. While some conventional network management tools may utilize conventional machine learning techniques for handling the large volumes of network events, they frequently fall short in delivering context-aware network diagnostics and troubleshooting features, leading to further delays in resolving the network issues.

### SUMMARY OF THE DISCLOSURE

Systems, devices, and methods for context-aware, Artificial Intelligence (AI)-driven network diagnostics and troubleshooting in accordance with embodiments of the disclosure are described herein. In many embodiments, a device comprises one or more processors, a network interface controller, and a memory communicatively coupled to the one or more processors. The network interface controller is configured to provide access to a network. The memory comprises a network diagnostics logic configured to: receive a user input indicative of an issue associated with the network, wherein the user input comprises a plurality of first logs associated with a plurality of network devices in the network. The network diagnostics logic is further configured to derive at least one diagnostic context based on the user input, determine a network topology from the at least one diagnostic context, extract network log data from a plurality of second logs based on at least one of the user input, the network topology, or configurable criteria, identify, from the extracted network log data, a root cause of the issue, and generate at least one recommendation based on the root cause to address the issue.

In a number of embodiments, the user input comprises at least one of: a description of the issue, an indication regarding one or more subsystems within each of the plurality of network devices, a time range, or one or more topology-specific filter criteria.

In a variety of embodiments, the configurable criteria comprise at least one of: a time range configured to target a period when the issue occurred, or an indication regarding one or more subsystems within the plurality of network devices.

In various embodiments, the network diagnostics logic is further configured to automatically determine the time range to extract the network log data from the plurality of second logs, based on the user input and one or more event correlations in the plurality of first logs.

In more embodiments, the network diagnostics logic is further configured to store the extracted network log data in a vector database.

In additional embodiments, the network diagnostics logic is further configured to store the user input, the at least one diagnostic context, and the extracted network log data in a context database.

In further embodiments, the context database is configured as a reusable knowledge base to provide automated diagnostics for one or more subsequent issues.

In still more embodiments, the network diagnostics logic is further configured to execute a machine learning model to identify the root cause of the issue.

In still further embodiments, the machine learning model is a large language model.

In still additional embodiments, the network diagnostics logic is further configured to: generate one or more prompts for the machine learning model based on at least one of: the user input, the extracted network log data, the network topology, one or more pre-processed bug signatures associated with the issue, or a vector database associated with the extracted network log data; and input the one or more prompts to the machine learning model, wherein the root cause of the issue is identified based on an output of the machine learning model for the one or more prompts.

In some more embodiments, the at least one diagnostic context comprises one or more command line interface commands associated with the issue, the extracted network log data, and the user input.

In yet various embodiments, the issue is a previously unclassified issue.

In yet more embodiments, the at least one recommendation corresponds to one of a bug match for the issue or at least one summary associated with the issue.

In still yet more embodiments, the network diagnostics logic is further configured to: render a conversational interface for receiving one or more queries associated with the plurality of second logs; translate the received one or more queries into at least one command corresponding to the network; and extract the network log data from the plurality of second logs further based on the at least one command.

In many further embodiments, the network diagnostics logic is further configured to: select a natural language processing parser based on one or more formats associated with the plurality of first logs; and parse the plurality of first logs based on the selected natural language processing parser, wherein the at least one diagnostic context is derived based on the parsed plurality of first logs.

In many additional embodiments, the memory comprises a network diagnostics logic configured to: receive a user input indicative of an issue associated with the network, wherein the user input comprises a plurality of logs associated with a plurality of network devices in the network. The network diagnostics logic is further configured to run the user input through a filter pipeline; derive at least one diagnostic context associated with the issue from an output of the filter pipeline; augment a prompt template based on the at least one diagnostic context; identify a root cause of the issue based on the augmented prompt template; and generate at least one recommendation based on the root cause to address the issue.

In still yet further embodiments, the issue is a previously classified issue.

In still yet additional embodiments, the at least one diagnostic context comprises a network topology, network log data, a time range, or one or more topology-specific filter criteria associated with the issue.

In several embodiments, the network diagnostics logic is further configured to input the augmented prompt template to a machine learning model, wherein the root cause of the issue is identified based on an output of the machine learning model.

In several more embodiments, a method comprises receiving a user input indicative of an issue associated with a network, wherein the user input comprises a plurality of first logs associated with a plurality of network devices in the network; deriving at least one diagnostic context based on the user input; determining a network topology from the at least one diagnostic context; extracting network log data from a plurality of second logs based on at least one of the user input, the network topology, or configurable criteria; identifying, from the extracted network log data, a root cause of the issue; and generating at least one recommendation based on the root cause to address the issue.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a network diagnostics logic may operate on a plurality of network devices in accordance with various embodiments of the disclosure;

FIG. 2 is a schematic diagram illustrating various subsets of Artificial Intelligence (AI) in accordance with various embodiments of the disclosure;

FIG. 3 is a block diagram illustrating different methods of machine-based learning in accordance with various embodiments of the disclosure;

FIG. 4 is a block diagram illustrating a machine learning lifecycle in accordance with various embodiments of the disclosure;

FIG. 5 is a schematic diagram illustrating an example neural network in accordance with various embodiments of the disclosure;

FIG. 6 is a block diagram illustrating a context-aware, AI-driven network diagnostics and troubleshooting system in accordance with various embodiments of the disclosure;

FIG. 7 is a block diagram illustrating a natural language query engine for context-aware, AI-driven network diagnostics and troubleshooting in accordance with various embodiments of the disclosure;

FIG. 8 is a flowchart depicting a process for context-aware, AI-driven network diagnostics and troubleshooting of a previously unclassified issue in accordance with various embodiments of the disclosure;

FIG. 9 is a flowchart depicting a process for diagnosing a previously unclassified issue associated with a network in accordance with various embodiments of the disclosure;

FIG. 10 is a flowchart depicting a process for context-aware, AI-driven network diagnostics and troubleshooting of a previously classified issue in accordance with various embodiments of the disclosure;

FIG. 11 is a flowchart depicting a process for diagnosing a previously classified issue associated with a network in accordance with various embodiments of the disclosure; and

FIG. 12 is a conceptual block diagram of a device suitable for configuration with the network diagnostics logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for context-aware, Artificial Intelligence (AI)-driven network diagnostics and troubleshooting. Network diagnostics may refer to a process for identifying and analyzing issues associated with a network, and determining root causes of the issues, to maintain an optimal performance of the network and smooth functioning of devices, systems, and services connected to the network. The issues associated with the network, hereinafter referred to as “network issues,” may include, for example, connectivity issues, interface errors, slow performance, bottlenecks, congestion, packet losses, security breaches, hardware failures, or the like. Network diagnostics may involve monitoring and assessing the health of the network to identify abnormal behavior or performance drops. In many embodiments, network diagnostics may include analyzing logs generated by multiple network devices such as switches, routers, servers, systems, applications, or the like associated with the network. The term “log” may refer to a record that documents and provides insights on various events, activities, and transactions occurring within the network. The logs may include, for example, detailed information or data about every network device, link, network event or activity, network traffic, application data, system-level event, interaction, transaction, network traffic including data packets, connection attempts, bandwidth usage, or the like, in the network. An event associated with the network may refer to any occurrence or change in a state of the network, that is significant enough to be detected, be monitored, and potentially require an action. Further, troubleshooting may refer to a process for resolving the network issues identified during network diagnostics and restoring normal operation of the network. Once a network issue is diagnosed, for example, by identifying a root cause of the network issue, troubleshooting steps may be executed to resolve the network issue. The troubleshooting steps may include, for example, reconfiguring the network devices, replacing faulty hardware such as a transceiver, adjusting network settings, disabling network security components such as a Bridge Protocol Data Units (BPDUs) guard, or the like.

Analysis of the logs may involve parsing and interpreting the logs to understand the health, performance, and security of the network. However, there may be substantial complexity in analyzing the logs generated by multiple network devices. Conventional network management tools such as search and analytics engines, data ingestion tools, data visualization tools, or the like may provide log search and data visualization capabilities, empowering users to visualize data and perform keyword searches. However, these network management tools may fall short in delivering context-aware, diagnostic, and troubleshooting features including, for example, extracting topologies from the logs, and may necessitate manual command inputs or the use of precise search terms to extract relevant network log data. Some conventional network management tools such as incident management systems, bug tracking systems, or the like may store known network issues and solutions, but may not directly interface with live or historical logs, requiring manual cross-referencing to correlate the logs with the known network issues. Further, while some network management tools may utilize machine learning to identify unusual patterns and detect anomalies, these tools primarily alert users to the unusual patterns without providing specific diagnostic insights into the root causes or suggesting remedial commands, thereby failing to provide actionable recommendations.

The present disclosure addresses the above-mentioned challenges by providing systems, devices, and methods for context-aware, AI-driven network diagnostics and troubleshooting. In a number of embodiments, the systems, devices, and methods discussed herein may provide an AI-driven Network Diagnostics and Troubleshooting (NDT) system that may employ logs, for example, show tech logs, to provide recommendations including actionable recommendations for resolving device scope or network wide issues. Show tech logs may refer to technical support logs obtained by running a show tech command (sh tech), also referred to as a “show tech-support” command. The show tech command may display diagnostic information for technical support by running relevant or all show commands on hardware, for example, on the network devices. In a variety of embodiments, the systems, devices, and methods discussed herein may process detailed network log data about network device features, for example, switch features, received from the logs by automatically running some or all show commands associated with the network device features. In various embodiments, the AI-driven NDT system may dynamically build context-aware diagnostics through interactive user input, while refining general problem descriptions into specific diagnostic contexts. In more embodiments, the AI-driven NDT system may utilize these diagnostic contexts to derive or map with a network topology, an intent associated with the network issue, and relevant time ranges in subsystems of single or multiple network devices to extract and process only relevant network log data, ensuring an optimal and scalable log analysis.

In additional embodiments, the AI-driven NDT system may initiate the process by identifying subsystems within network devices, network devices of interest, and a time range for the log analysis. The AI-driven NDT system may then extract logs from multiple network devices such as routers, switches, or other network components, based on filter criteria including, for example, topology-specific entry filters derived from the intent. The filter criteria may allow inclusion of only the logs relevant to the network issue, thereby reducing noise and in turn, the data size, and focusing only on information needed for the log analysis. In further embodiments, the AI-driven NDT system may then normalize, time-order, and format the logs to facilitate event correlation across the network devices, enabling the AI-driven NDT system to highlight relationships between items or entries in the logs that allow diagnosis of the network issue. In still more embodiments, the AI-driven NDT system may time-order the logs from various subsystems within the network devices and across the network devices.

In still further embodiments, the AI-driven NDT system may utilize one or more of the diagnostic contexts to select an appropriate template, for example, a Retrieval-Augmented Generation (RAG)-based template and a vector database. The vector database may refer to a collection of data stored as mathematical representations. In still additional embodiments, the vector database may allow machine learning models to remember previous inputs easily, further allowing machine learning to be utilized to power search, execute text generation use-cases, and generate recommendations. The AI-driven NDT system may then utilize the extracted logs in the RAG queries and feed the extracted logs into a machine learning model, for example, a custom-trained Large Language Model (LLM). By utilizing reduced logs with focused RAG and inputs, the LLM can identify known network issues, evaluate relationships between relevant entries in the extracted logs, and provide actionable recommendations. The precision obtained from reducing the logs may avoid extraneous information that can obscure the diagnosis, allowing the AI-driven NDT system to provide clear insights into actual root causes or corrective actions for the network issue reported by a user.

In some more embodiments, to enhance focus, the AI-driven NDT system may implement automatic time windowing where the AI-driven NDT system may determine failure time windows across network devices or clients to extract logs within a defined time range, thereby ensuring the log analysis is relevant and noise-free. Auto time windowing may refer to an automatic determination of time ranges, intervals, or “windows,” that may be utilized for analyzing time-series data or events in the logs over a given period. In yet various embodiments, the AI-driven NDT system may break up continuous network log data into manageable chunks of time, allowing patterns, trends, or anomalies to be identified more easily. Determining failure time windows may include, for example, identifying time ranges or intervals during which failures or incidents occur and analyzing patterns, causes, and impact of these failures. In yet more embodiments, automatic time windowing may facilitate filtering of the logs for log analysis based on the intent and determining cumulative failure events across the network devices and subsystems to minimize noise and ensure that only the most relevant logs are analyzed, saving time and improving focus. The AI-driven NDT system may focus the log analysis within the time windows, also referred to as “time ranges,” enhancing precision and reducing noise. In still yet more embodiments, by integrating historical context and associated data from previous troubleshooting sessions, the AI-driven NDT system may match a current problem against known network issues, suggesting potential bug matches or expert-generated summaries. In cases where no match exists, the AI-driven NDT system may generate a detailed, analyzed summary, providing insights for subject matter experts to continue diagnostics and iterate with the AI-driven NDT system.

In many further embodiments, the AI-driven NDT system may receive feedback on the accuracy of findings of the machine learning model, effectiveness of the diagnostic contexts, and effectiveness of the filter criteria and how the filter criteria may be refined, allowing the AI-driven NDT system to continuously learn, improve results, and refine diagnostic workflows over time. In many additional embodiments, the AI-driven NDT system may implement reinforcement learning over time to further enhance the ability of the AI-driven NDT system to deliver precise and relevant recommendations. In still yet further embodiments, the AI-driven NDT system may store the diagnostic contexts including, for example, Command Line Interface (CLI) commands, log extracts, user-provided descriptions and symptoms of the network issues, diagnostic workflows, findings, or the like in a context database, creating a reusable knowledge base with reusable diagnostic contexts utilized for training the machine learning model, which may also help improve future diagnostics, collaborative learning, and knowledge sharing across teams.

The AI-driven NDT system may implement context-aware, topology-driven, and intent-based diagnostics and troubleshooting workflows. In still yet additional embodiments, the AI-driven NDT system may dynamically derive the network topology from the logs based on the intent associated with the network issue. In several embodiments, the AI-driven NDT system may select an appropriate RAG filter database and related prompts based on the intent. In several more embodiments, the AI-driven NDT system may support context-aware diagnostics across multiple network devices based on a selected intent and a time range to filter the logs received from the network topology. The filter criteria for filtering the logs may include, for example, a selection of specific types of log entry masks from relevant network devices. The resulting log extracts constituting network log data, after the filtering, may be included as part of an augmented query, for example, a RAG-augmented query, made into the machine learning model such as the LLM, which may diagnose whether specific problems exist in that network topology. In numerous embodiments, the AI-driven NDT system may dynamically select relevant diagnostic commands and workflows based on the network topology and the intent. The AI-driven NDT system may, therefore, streamline network diagnostics and troubleshooting and with much-reduced RAG and normalized formatting for multiple network devices, the machine learning model may be able to quickly identify known network issues and provide insights into their root causes by removing extraneous information that may hinder and disguise relationships between the remaining relevant log entries.

The systems, devices, and methods discussed herein may provide context-aware, AI-driven network diagnostics and troubleshooting by combining structured diagnostic contexts, intelligent data extraction, semantic search capabilities, and LLM integration. By automatically extracting and organizing relevant network log data based on predefined diagnostic contexts, the AI-driven NDT system may eliminate the need for manual log searching, thereby allowing users, for example, network engineers, to quickly focus on critical network log data related to specific network issues, and significantly reducing time to diagnosis and resolution of the network issues. The use of shared diagnostic contexts may ensure that troubleshooting procedures are standardized and consistent across teams, regardless of individual skill levels. This consistency may minimize diagnostic errors and provide a more reliable troubleshooting approach across distributed teams.

Further, the vector database may allow semantic, context-aware searches, retrieving network log data that is highly relevant even if phrased differently. Additionally, utilizing RAG with diagnostic log extracts and LLMs may provide precise, contextually accurate answers, reducing irrelevant information and enhancing the reliability of responses. The structured approach of the AI-driven NDT system, with diagnostic contexts and issue classifications, allows the AI-driven NDT system to scale easily across complex and large network infrastructures. As new diagnostic scenarios emerge, new contexts can be added, making the AI-driven NDT system adaptable to evolving network environments. Further, by storing and sharing diagnostic contexts across users, the AI-driven NDT system may facilitate collaborative knowledge sharing and troubleshooting. The users can build on each other's diagnostic insights, leading to faster resolution times, better knowledge retention, and improved training opportunities for less experienced team members. With features such as predefined and dynamic prompt generation and LLM-powered answers, users can receive instant, actionable insights into network issues without sifting through extensive logs manually. The use of context-aware prompts may allow for proactive diagnostics, where emerging network issues can be flagged based on historical log patterns.

By combining topology-aware diagnostics, intent-driven log filtering, and RAG-augmented selection of queries, the AI-driven NDT system may address the challenges of inconsistent, unstructured logs and the need for cross-device event correlation. The AI-driven NDT system may accelerate the diagnostics and troubleshooting process, minimize noise, and ensure systematic diagnostics across multi-device topologies in data center environments. Further, the AI-driven NDT system may execute structured diagnostic contexts to automate network log data extraction and organization. Semantic search capabilities, powered by the vector database, enable precise retrieval of relevant network log data, even with varied phrasing. Integration with LLMs and RAG may provide contextually accurate and actionable insights from the network log data. This approach may enhance diagnostic efficiency, consistency, and accuracy, while scaling to complex network environments and fostering collaborative knowledge sharing. Through its focus on reusable diagnostic contexts, which may be utilized for training the machine learning model, and continuous improvement, the AI-driven NDT system may evolve into a robust tool for efficient and effective network diagnostics and troubleshooting over time. The systems, devices, and methods discussed herein may transform troubleshooting from a reactive, labor-intensive process to an efficient, structured, and collaborative approach. By integrating advanced AI techniques and diagnostic structures, the AI-driven NDT system may empower users with quicker, more accurate, and more consistent solutions for complex network issues.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In further additional embodiments, a circuit may include a return pathway for electric current, so that the circuit is a closed loop. In many embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In a number of embodiments, a circuit may include a portion of an integrated circuit, an integrated circuit, a set of integrated circuits, a set of non-integrated electrical and/or electrical components with or without integrated circuit devices, or the like. In a variety of embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

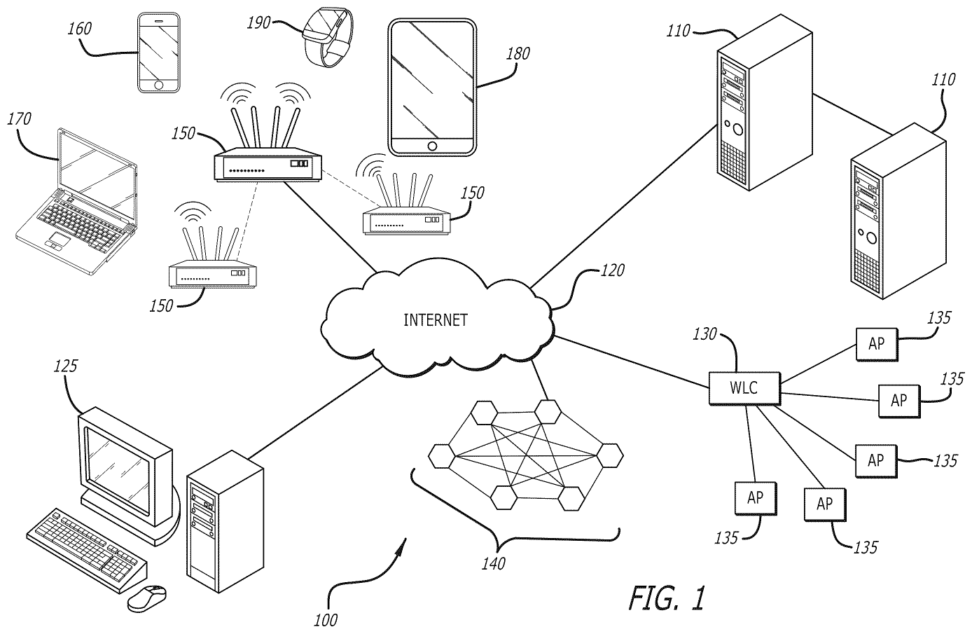

Referring to FIG. 1, a conceptual network diagram 100 of various environments in which a network diagnostics logic may operate on a plurality of network devices in accordance with various embodiments of the disclosure is shown. Those skilled in the art will recognize that the network diagnostics logic can include various hardware and/or software deployments and can be configured in a variety of ways. In many embodiments, the network diagnostics logic can be configured as a standalone device, exist as a logic in another network device, be distributed among various network devices operating in tandem, or be remotely operated as part of a cloud-based network management system. In a number of embodiments, one or more servers 110 can be configured with the network diagnostics logic or can otherwise operate as the network diagnostics logic. In a variety of embodiments, the network diagnostics logic may operate on one or more servers 110 connected to a communication network 120 (shown as the “Internet 120”). The communication network 120 can include wired networks or wireless networks. The network diagnostics logic can be provided as a cloud-based service that can service remote networks, such as, but not limited to, a deployed network 140.

In various embodiments, the network diagnostics logic may be operated as a distributed logic across multiple network devices. In the embodiment depicted in FIG. 1, a plurality of access points 150 can operate as the network diagnostics logic in a distributed manner or may have one specific device operate as the network diagnostics logic for all the neighboring or sibling access points 150. The access points 150 may facilitate Wi-Fi® connections for various electronic devices, such as, but not limited to, mobile computing devices including cellular phones 160, laptop computers 170, portable tablet computers 180, and wearable computing devices 190.

In more embodiments, the network diagnostics logic may be integrated within another network device. In the embodiment depicted in FIG. 1, a Wireless Local Area Network (LAN) Controller (denoted as “WLC”) 130 may have an integrated network diagnostics logic that the WLC 130 can utilize to monitor or control power consumption of a plurality of access points (denoted as “APs”) 135 to which the WLC 130 is connected and manage network events received by the access points 135, via either a wired connection or a wireless connection. In additional embodiments, a personal computer 125 may be utilized to access and/or manage various aspects of the network diagnostics logic, either remotely or within the communication network 120 itself. In the embodiment depicted in FIG. 1, the personal computer 125 communicates over the communication network 120 and can access the network diagnostics logic of the one or more servers 110, or the access points 150, or the WLC 130.

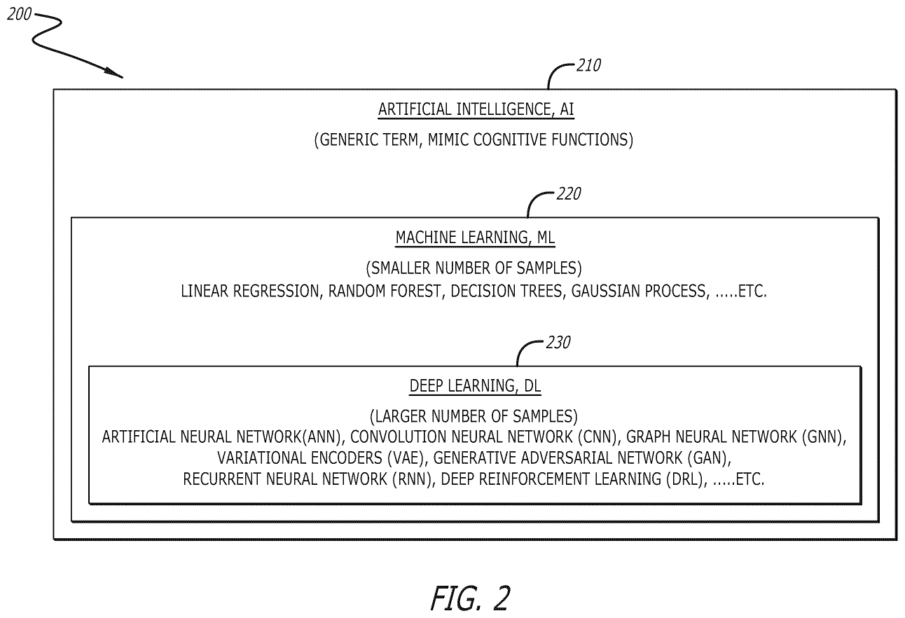

Although a specific embodiment for various environments in which a network diagnostics logic may operate on a plurality of network devices suitable for carrying out the various steps, processes, methods, and operations described herein is discussed with respect to FIG. 1, any of a variety of systems and/or processes may be utilized in accordance with embodiments of the disclosure. For example, the network diagnostics logic may be provided as a device or a software separate from the WLC 130 or the network diagnostics logic may be partially or wholly integrated into the WLC 130. The elements depicted in FIG. 1 may also be interchangeable with other elements of FIGS. 2-12 as required to realize a particularly desired embodiment.

Referring to FIG. 2, a schematic diagram 200 illustrating various subsets of artificial intelligence in accordance with various embodiments of the disclosure is shown. Artificial Intelligence (AI) 210 is typically understood in the art to be the development of machines and algorithms that mimic human intelligence, for example, by optimizing actions to achieve certain goals. At its core, AI 210 often involves designing algorithms and models that mimic cognitive functions, such as learning, reasoning, problem-solving, perception, and even language understanding. Unlike conventional computer programs that follow a fixed set of instructions, AI systems can adapt, improve, and make decisions based on input data and environmental interactions.

AI 210 can be considered a generic term because AI 210 encompasses a wide range of subfields and techniques, from simple rule-based systems to advanced machine learning and deep learning models. These AI techniques are utilized for simulating various aspects of human cognition. For example, Machine Learning (ML) 220 allows computers to learn from data patterns without explicit programming for each task, while Natural Language Processing (NLP) enables machines to understand and generate human language. Deep learning (DL) 230, a more advanced branch of AI 210, utilizes neural networks to automatically learn complex patterns from large datasets, akin to information processing by the human brain. This versatility makes AI 210 a powerful tool across diverse applications, including network diagnostics and troubleshooting, anomaly analysis, image recognition, autonomous driving, voice assistants, and materials discovery.

A goal of AI 210 is often to create systems that can function autonomously and intelligently in real-world scenarios. As AI 210 continues to evolve, AI 210 can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 220 is a subset of AI 210 that focuses on the development of algorithms and statistical models that enable computers to learn and make decisions from data without explicit programming. In conventional programming, a computer is given a fixed set of rules to follow, but ML 220 can shift this paradigm by allowing systems to identify patterns, adapt, and improve their performance based on the data they encounter. This data-driven approach makes ML 220 particularly valuable for tasks that are too complex or dynamic to define using straightforward rules, such as determining patterns associated with network events, recognizing images, predicting consumer behavior, or diagnosing network problems. In various embodiments described herein, machine-learning methods may be utilized for classifying network issues, generating relationship graphs, identifying correlations between logs generated by multiple network devices, identifying correlations between the network events, and prioritizing the network events.

ML models can be configured to analyze large amounts of data to identify trends and relationships that inform their predictions or classifications. The process typically involves three stages: training, validation, and testing. During training, the ML model learns from a dataset by adjusting its internal parameters to minimize errors between its predictions and the actual results. Techniques such as linear regression, decision trees, random forests, and Gaussian processes are commonly utilized in ML 220. These algorithms can handle various data types, including numerical, categorical, and structured datasets such as spreadsheets or grids. One of the strengths of ML 220 is its ability to generalize from training data to make accurate predictions on new, unseen data. In many embodiments described herein, training data may be generated from the logs associated with multiple network devices and diagnostic contexts stored, for example, in a context database, among other sources.

However, conventional ML methods may rely heavily on feature engineering, wherein human experts manually identify the most relevant features or patterns within the data. For example, when using ML 220 for classifying network issues, an expert may need to extract features such as timestamps, device information such as device identifier, type of device, or the like, source and destination Internet Protocol (IP) addresses, source and destination ports, event type, a protocol utilized, error rates, connection attempts and failures, session duration, or the like, before feeding them into the ML model. This requirement can limit the scalability of conventional ML approaches, especially when dealing with large, unstructured datasets such as images, text, or graphs. Additionally, ML algorithms may often work best when provided with relatively structured data, and they often need a reasonable number of samples (typically more than 100) to learn effectively.

DL 230 is a specialized subset of ML 220 that employs multi-layered artificial neural networks to automatically learn complex patterns and representations from large, often unstructured datasets. Inspired by the way the human brain processes information, DL 230 includes interconnected layers of “neurons” that can adaptively change as they are exposed to more data. Unlike conventional ML methods, which require manual feature engineering to identify data characteristics, DL models can automatically extract features directly from raw data, such as images, text, or data structures. This automated feature extraction allows DL 230 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as network log data, network traffic, network structures, atomic interactions, or the like. GNNs can learn the dependencies and relationships within graph-like structures, which may facilitate predicting properties of complex patterns, network log data, network traffic, and materials. For example, the features of the network log data are modeled as a graph and may be input into a GNN for classifying a state or a status of each network device in the graph as compromised, underperforming, or operating normally, or classifying whether there is a security breach, whether a network segment is healthy, whether an event is normal or anomalous, or whether a network issue is a connectivity issue, a performance issue, a security issue, or a configuration issue. By organizing the features of the network log data into a graph structure, situations where unknown patterns generated by previously unclassified network issues may be handled optimally. RNNs and their variants, such as Long Short-Term Memory (LSTM) networks, are suited for sequential data such as time series or NLP, allowing for the analysis and generation of textual information or the prediction of temporal patterns in scientific research.

One of the defining characteristics of DL 230 is its requirement for large datasets (typically over 500 samples for example) to effectively train neural networks. While the deep, multi-layered structure of these networks enables them to capture highly complex and abstract representations of the data, they also demand significant computational power. Techniques such as Variational Autoencoders (VAEs) and Generative Adversarial Networks (GANs) add to the versatility of DL 230 by enabling the generation of new data samples that resemble a training dataset, aiding in areas such as materials discovery and synthetic data creation. Deep Reinforcement Learning (DRL) combines neural networks with decision-making processes to solve problems that involve optimization and control, further expanding the application potential of DL 230. In summary, the ability of DL 230 to automatically learn from raw, unstructured data and model intricate patterns makes DL 230 a powerful tool in AI 210, particularly for complex domains such as image recognition, NLP, and materials science.

Artificial Neural Networks (ANNs or sometimes merely NNs) are often a foundation of a DL system. The basic unit of a neural network is typically a perceptron, which can take inputs, assigns weights to these inputs, and combines them to produce an output. The final output is then passed through an activation function, for example, a Rectified Linear Unit (ReLU), a sigmoid, or a hyperbolic tangent, to introduce non-linearity, which enables the network to model complex patterns.

Neural networks are typically trained through a process of backpropagation, where predictions of an AI system are compared against a known output, and a loss function is utilized to measure the difference between the prediction and the actual result. The weights assigned by the neural network can be adjusted through a process called gradient descent, which can be configured to minimize the loss function over time. However, the training process can be prone to problems such as overfitting, where the ML model performs well on the training data but poorly on new data. To counter this, techniques such as regularization (e.g., dropout), early stopping, and mini-batches can be utilized to prevent the neural network from becoming overly specialized to the training dataset.

CNNs are a specific type of ML neural network designed to work particularly well with network log data, making them highly relevant for classifying network issues, which may be subject to processing. As those skilled in the art will recognize, CNNs typically utilize specialized layers known as convolutional layers, which apply filters (also known as kernels) to the input data. These filters slide over the input (e.g., an input power value), detecting patterns such as edges or textures, which are then passed to the next layer for further processing. CNNs can automatically learn and extract relevant features from raw data without the need for manual feature engineering. Furthermore, pooling layers (e.g., max-pooling or average pooling) are often added after convolutional layers to reduce the dimensionality of the data, helping to make the AI system more efficient while retaining the most important information. After several layers of convolutions and pooling, the CNN can output a prediction, such as whether the network event is normal, critical, or anomalous.

While CNNs are well-suited for grid-based data like images, many real-world problems can involve non-grid data, such as logs, alerts, or the like. This type of data may better be represented as a graph, where nodes represent entities (e.g., network devices, Internet Protocol “IP” addresses, applications, or the like) and edges represent relationships between them (e.g., communication patterns or data flows between the network devices and the applications). Thus, Graph Neural Networks (GNNs) can be utilized to operate on such graph-based data.

In GNNs, information is passed between the nodes through the edges in a process called message passing. This allows the neural network to capture dependencies and relationships within the graph structure. GNNs can aggregate information from neighboring nodes, which is utilized in predicting properties that depend on the current/local structure, such as the behavior of the applications or the properties of the network devices.

Generative models aim to learn the underlying distribution of a dataset and generate new samples that resemble the original data. Two common types of generative models are VAEs and GANs. VAEs are often configured to work by encoding data into a lower-dimensional latent space and then decoding the data back into its original form, which allows for the generation of new data by sampling points from the latent space. This can be utilized when attempting to construct a graph based on features of the network log data and the network devices or applications. Similarly, GANs include two components: a generator that creates fake or generated data and a discriminator that attempts to distinguish between real data and fake data. The two components are trained in a competitive process where the generator attempts to “fool” the discriminator, leading to increasingly realistic generated data. This type of process may be utilized to produce synthetic samples that resemble the training data, which can help augment the training dataset.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex network log simulations.

In network diagnostics and troubleshooting, DRL can be utilized in scenarios where an optimal decision needs to be made, such as classifying the network issue, identifying a root cause of the network issue, generating at least one recommendation based on the root cause to address the issue, or the like based on various features such as timestamps, device information such as device identifier, type of device, or the like, source and destination IP addresses, source and destination ports, event type, a protocol utilized, error rates, connection attempts and failures, session duration, etc. The combination of RL and DL 230 can allow for learning from raw data, making it a powerful tool for dynamic and real-time decision-making for network diagnostics and troubleshooting.

Although a specific embodiment for various subsets of artificial intelligence suitable for carrying out the various steps, processes, methods, and operations described herein is discussed with respect to FIG. 2, any of a variety of systems and/or processes may be utilized in accordance with embodiments of the disclosure. For example, another subset such as transformer networks, capsule networks, or the like may be present and available for use within AI 210. Those skilled in the art will recognize that the schematic diagram 200 presented in FIG. 2 is simplified for illustration purposes and various methods and techniques may interact with other areas (ML 220 with DL 230, etc.). The elements depicted in FIG. 2 may also be interchangeable with other elements of FIG. 1 and FIGS. 3-12 as required to realize a particularly desired embodiment.

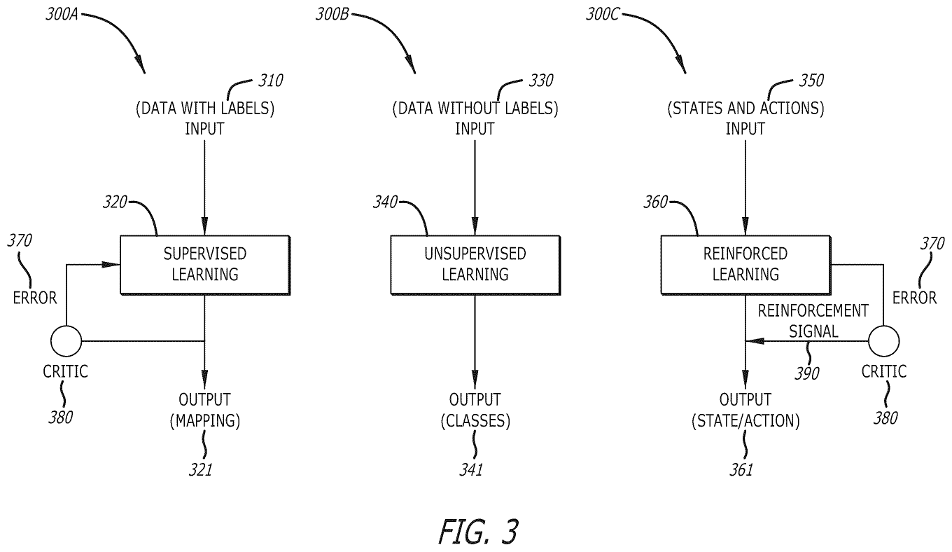

Referring to FIG. 3, a block diagram illustrating different methods of machine-based learning in accordance with various embodiments of the disclosure is shown. In many embodiments, an ML model is defined as a mathematical representation of an output of a training process. An ML model is often considered similar to computer software designed to recognize patterns or behaviors based on previous experience or data. An ML algorithm can discover patterns within training data, and output an ML model which can capture these patterns and make predictions on new data.

ML models may be interpreted as devices that have been trained to find patterns within new data and make predictions. These ML models can be represented as complex mathematical functions that would be impractical for a human to calculate, that takes requests in the form of input data, makes predictions on input data, and then provides an output in response. These ML models can be trained over a set of data, and then they may be provided an algorithm or other task to reason over the data, extract patterns from feed data, and learn from that data. Once the ML models are trained, they can be utilized to predict a new and previously unseen dataset.

There are various types of ML models available based on different business goals and datasets available. Often, based on the desired application, ML models can be configured as or settled into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 3, a supervised learning system 300A is shown. The supervised learning system 300A can be configured with a supervised learning model 320 that accepts input data 310 and generates output data 321. The output data 321 is often reviewed by a critic 380 that can determine an error 370 that is fed back into the supervised learning model 320 for use in updating.

Supervised learning systems 300A are often considered the simplest ML model to understand which input data (such as training data) has a known label or result as an output. The supervised learning model 320 can, therefore, be understood to work on the principle of input-output pairs. As such, a function can be trained using a training dataset, which is then applied to unknown data to make some predictions. Supervised learning is task-based and mostly tested on labeled datasets.

Supervised learning systems 300A may often involve one or more regression problems. In regression problems, the output is a continuous variable. Examples of commonly utilized regression models include linear regression, decision trees, and random forests. Linear regression is typically the most straightforward ML model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this linear equation may be represented in the form of a line: y=bx+c. A typical aim of a linear regression-based model can be to find an optimal fit line that best fits available data points. Linear regression can be extended to multiple linear regressions (finding a plane of best fit in a higher dimensional space) and polynomial regressions (finding the best fit curve). Decision trees are also popular ML models that can be utilized for both regression and classification problems. A decision tree utilizes a tree-like structure of decisions along with their possible consequences and outcomes. In a decision tree, each internal node is utilized to represent a test on an attribute while each branch is utilized to represent the outcome of the test. The more nodes a decision tree has, the more accurate the result will be. This may be utilized when making decisions related to network issues and their separation. Decision trees are intuitive and easy to implement, but may lack accuracy depending on computational or time resources available.

Random forests are an ensemble learning method, which may include a large number of decision trees. For example, each decision tree in a random forest predicts an outcome, and the prediction with a majority of votes is considered as the outcome. A random forest model can be utilized for both regression and classification problems. For a classification task, the outcome of the random forest may be taken from the majority of votes. Whereas in a regression task, the outcome can be taken from a mean or an average of the predictions generated by each tree.

Classification models are the other type of supervised learning, which can be utilized for generating conclusions from observed values in one or more categorical forms. For example, a classification model can identify if an email is spam or not; whether network events are normal or anomalous, etc. Classification algorithms can also be utilized for predicting between two or more classes and/or categorize an output into different groups. For these classification systems, a classification model can be designed that classifies a dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be utilized for solving various classification problems in machine learning systems. These processes are similar to linear regression but are often utilized for predicting categorical variables. While some variations can be configured to generate a prediction as an output in either “yes” or “no,” 0 or 1, “true” or “false,” etc., in a number of embodiments, the system can instead be configured to not give exact values, but instead provide probabilistic values between zero and one.

Another classification process that can be utilized is a Support Vector Machine (SVM) which is widely utilized for classification and regression tasks. However, the main aim of the SVM is to find the best decision boundaries in an N-dimensional space, which can be utilized for segregating data points into classes, and generate a best decision boundary often known as a hyperplane. SVM processes can select an extreme vector to find a hyperplane, wherein this vector is known as a support vector.

Naïve Bayes is another popular classification algorithm utilized in machine learning. This classification process is based on Bayes' theorem and follows a naïve (independent) assumption between features which is often based on the following formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as a posterior chance being a result of prior results times the likelihood divided by evidence available. Each Naïve Bayes classifier assumes that the value of a specific variable is independent of any other variable/feature. For example, if a fruit needs to be classified based on color, shape, and taste, yellow, oval, and sweet will be recognized as mango. In this example, each feature is independent of other features. Likewise, various embodiments herein can classify the network issues into categories such as connectivity issues, performance issues, security issues, configuration issues, or the like.

Further, in the embodiment depicted in FIG. 3, an unsupervised learning system 300B is shown. The unsupervised learning system 300B can be configured with an unsupervised learning model 340 that accepts input data 330 and generates an output 341. Unlike other model types, there are no critics or error signals to process. Unsupervised learning models 340 can implement a learning process opposite to supervised learning, which means the learning process enables a model to learn from an unlabeled training dataset. Based on the unlabeled training dataset, the unsupervised learning model 340 can predict the output 341. Using the unsupervised learning system 300B, the unsupervised learning model 340 can learn hidden patterns from the unlabeled training dataset by itself without any supervision. In a variety of embodiments, unsupervised learning models 340 are often utilized for performing tasks involving clustering, association rule learning, and/or dimensional reduction.

Clustering is an unsupervised learning technique that involves clustering or grouping the available data points into different clusters based on similarities and/or differences. The data points or objects with the most similarities remain in the same group, and they have no or very few similarities from other groups. Clustering algorithms can be utilized in various tasks such as, but not limited to, image segmentation, statistical data analysis, market segmentation, or the like. Some commonly utilized clustering algorithms that can be selected include, for example, K-means clustering, hierarchal clustering, Density-based Spatial Clustering of Applications with Noise (DBSCAN), etc.

Association rule learning is an unsupervised learning technique which finds unique relations among variables within a large dataset. In various embodiments, a primary aim of this type of learning algorithm is to find a dependency of one data item on another data item and map those variables accordingly to satisfy a desired outcome. For example, in more embodiments, an association rule system may be utilized for identifying relationships between different entries in logs and classifying the network issues. This learning algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique utilized to reduce the dimensionality is known as a dimensionality reduction technique. Although more data provides more accurate results, more data can also affect the performance of the model/algorithm, for example, by yielding overfitting outcomes. In such cases, dimensionality reduction techniques can be utilized. Dimensionality reduction techniques involve converting a higher-dimensional dataset into a lower-dimensional dataset while also ensuring that the ensuing results provide similar information. Different dimensionality reduction methods can be utilized, such as, but not limited to, Principal Component Analysis (PCA), Singular Value Decomposition (SVD), etc.

Further, in the embodiment depicted in FIG. 3, a reinforcement learning system 300C is shown. The reinforcement learning system 300C can be configured with a reinforcement learning model 360 that accepts input data 350 and generates an output 361. In reinforcement learning, the reinforcement learning model 360 learns actions for a given set of states that lead to a goal state. In the embodiment depicted in FIG. 3, a critic 380 can receive or otherwise notice an error 370 within the reinforcement learning model 360 actions, and transmit a reinforcement signal 390 to adjust the outcome/output such that the “reward” or “punishment” is adjusted to better model the future behaviors or processing of the reinforcement learning model 360.

The reinforcement learning model 360 is a feedback-based learning model that can take feedback signals after each state or action by interacting with the environment. This feedback works as a reward (positive for each good action and negative for each bad action), and an AI agent's goal is to maximize the positive rewards to improve their performance. The behavior of the reinforcement learning model 360 in reinforcement learning is similar to that of human learning, as humans learn things by experiences as feedback and interact with an environment. Popular methods of reinforcement learning including Q-learning, State-Action-Reward-State-Action (SARSA), and deep Q network.

Q-learning is one of the popular model-free algorithms of reinforcement learning, which is based on the Bellman equation. Q-learning often aims to learn a policy that can help an AI agent to take the best action for maximizing a reward under a specific circumstance. Q-learning can incorporate a Q-value for each state-action pair that indicates the reward to following a given state path, and tries to maximize that Q-value.

SARSA is an on-policy algorithm based on the Markov decision process. In further embodiments, SARSA can use the action performed by the current policy to learn the Q-value. The SARSA algorithm stands for State Action Reward State Action, which symbolizes the tuple (s, a, r, s′, a′). A Deep Q-Network (or DQN) implements Q-learning within a neural network. The DQN can be deployed within a big state space environment where defining a Q-table would be a complex task. In these embodiments, rather than using a Q-table, the DON utilizes Q-values for each action based on the state.

Although a specific embodiment for different methods of machine-based learning suitable for carrying out the various steps, processes, methods, and operations described herein is discussed with respect to FIG. 3, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 3 may also be interchangeable with other elements of FIGS. 1-2 and FIGS. 4-12 as required to realize a particularly desired embodiment.

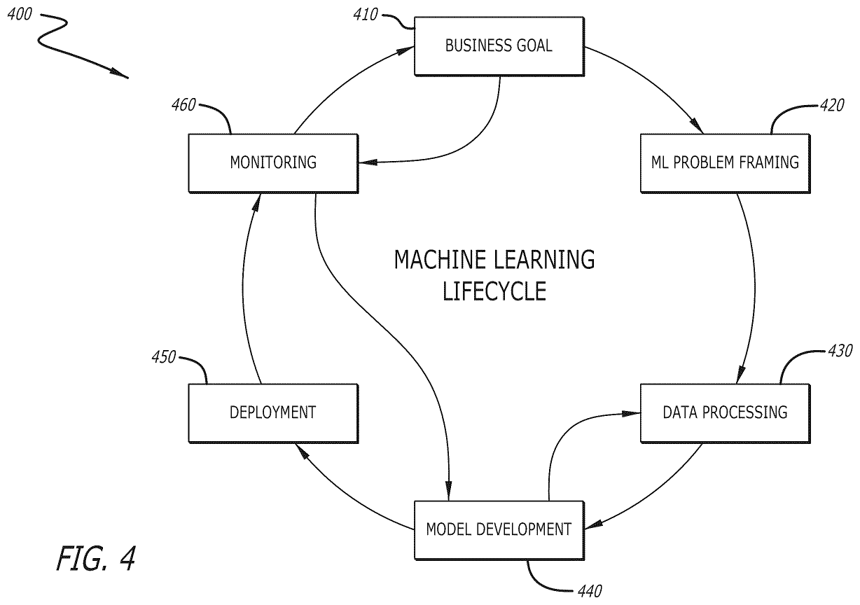

Referring to FIG. 4, a block diagram illustrating a machine learning lifecycle 400 in accordance with various embodiments of the disclosure is shown. While developing machine learning systems, the embodiment depicted in FIG. 4 can provide a framework for structuring the design and maintenance of these machine learning systems. The machine learning lifecycle 400 outlines various stages involved in building, deploying, and improving ML models to solve real-world problems. By following this structured process, businesses and organizations can ensure that their ML projects align with strategic goals, utilize data effectively, and adapt to changing conditions over time. This machine learning lifecycle 400 emphasizes that developing an ML model is not a one-time effort but an iterative process requiring ongoing monitoring and adjustment. A feedback loop inherent in the machine learning lifecycle 400 allows for continual refinement and optimization of the ML models to maintain their accuracy and relevance.

In many embodiments, a first stage of the machine learning lifecycle 400 includes identifying a business goal 410, which sets an overall direction and purpose for an ML project. Identifying the business goal 410 can involve understanding specific problems or opportunities within a business or a project that machine learning can address. A clear business goal 410 ensures that the project remains focused on delivering tangible value, whether it is classifying network issues or distinguishing between normal network events and anomalous network events. Without a well-defined business goal 410, it can be challenging to align subsequent stages of the machine learning lifecycle 400, as the choice of model, data processing methods, and performance metrics can all depend on what the business aims to achieve.

Establishing a proper business goal 410 can also involve engaging with key stakeholders and developers to gather requirements and set success criteria, which can provide a roadmap that outlines what success looks like and helps in framing an ML problem. For example, if the goal is to classify network issues, the project may focus on developing an ML model that utilizes network log data extracted from logs generated by multiple network devices for distinguishing between connectivity issues, performance issues, and security issues, and identifying root causes of the network issues. Clearly defined business goals not only help guide the project but also provide benchmarks for evaluating the effectiveness of the deployed ML model once the deployed ML model enters production.

Once the business goal 410 is established, various embodiments take a next step involving ML problem framing 420, wherein the business goal 410 is translated into a specific machine learning task. This can involve selecting the appropriate type of ML problem, such as classification, regression, clustering, or recommendation, and defining target variables or outputs. For example, if the business goal 410 is to classify network issues as connectivity issues, performance issues, or security issues, the problem can be framed as a regression task where the ML model treats features of the network log data such as error rates, connection attempts and failures, network traffic metrics, device and system performance metrics, or the like as variables and a severity score as a metric for identifying the root causes of the issues and generating recommendations. Proper ML problem framing 420 can determine particular data requirements, choice of model, and evaluation metrics.

During the stage of ML problem framing 420, it is also prudent to consider constraints and assumptions that may affect the development of the ML model. The constraints and assumptions may include, for example, data availability, computational resources, ethical considerations, or regulatory compliance. Properly framing the ML problem ensures that the development of the ML model aligns with the needs of the business and that the ML problem is broken down into manageable steps, ultimately increasing the project's chances of success.

Data processing 430 is a stage in many embodiments where raw data is collected, cleaned, and transformed into a format suitable for machine learning. This stage of the machine learning lifecycle 400 can involve gathering data from various sources, removing errors or inconsistencies, handling missing values, and normalizing or scaling features to ensure that the ML model can learn effectively. Feature engineering is often a part of this stage, where new features are derived from the raw data to capture more relevant information and improve model performance.

The quality and preparation of the utilized data can significantly impact the accuracy and reliability of the ML model. Inadequate or poorly processed data can lead to biased or inaccurate predictions, no matter how advanced the ML model is. Hence, data processing 430 can require or at least benefit from careful planning and iterative refinement. Once the data is processed, the data is typically split into training, validation, and test datasets to develop and evaluate the ML model, ensuring that the ML model generalizes well to new, unseen data.

Model development 440 is a stage, in a number of embodiments, where machine learning algorithms are selected, trained, and refined to create an ML model that addresses the framed problem. This stage can involve choosing an appropriate algorithm (e.g., decision trees, neural networks, support vector machines, or the like), setting up the architecture of the ML model, and defining hyperparameters that may guide the training process. The ML model is trained on the processed data to identify patterns and relationships that allow the ML model to make predictions or decisions.

During model development 440, the ML model can be evaluated using the validation dataset to finetune its parameters and improve performance. Techniques such as cross-validation, regularization, and hyperparameter tuning can be utilized to prevent overfitting and ensure the ML model generalizes well. If proper steps are taken, the result is an ML model that, once the ML model meets predefined performance metrics, is ready for deployment in a real-world environment. However, model development 440 often involves several iterations to optimize the ML model for the specific business goal, indicated by an arrow directed back to data processing 430.

In a variety of embodiments, deployment 450 is the stage of the machine learning lifecycle 400 where the developed ML model is integrated into a production environment to perform its intended tasks. This stage may involve setting up necessary infrastructure, such as Application Programming Interfaces (APIs) or cloud-based services, to allow the ML model(s) to process live data and generate predictions. Deployment 450 can transform the ML model from a research tool into a functional component of a business process or product, providing real-time insights, automations, or decisions.

Proper deployment 450 can also include setting up mechanisms for logging, error handling, and user access. Since real-world environments are often dynamic and differ from training conditions, deployment 450 may require continuous adaptation and updates to ensure the ML model(s) operates efficiently. This stage may define the success of the ML model because the ML model's success is not only determined by its performance metrics but also by its ability to provide actionable results that align with the business goal 410.

In various embodiments, monitoring 460 is an ongoing process of tracking the performance and behavior of the ML model after deployment 450. Monitoring 460 involves collecting data on the ML model's predictions, accuracy, latency, and error rates to detect issues such as concept drift, where changes in the underlying data patterns can degrade the accuracy of the ML model. By continuously monitoring 460, teams can identify when the performance of the ML model drops and requires retraining or adjustments to align with evolving data.

Monitoring 460 can also encompass aspects such as user feedback, security, and compliance, ensuring that the ML model remains effective, reliable, and ethical in its application. Monitoring 460 may serve as a feedback loop in the machine learning lifecycle 400, where insights gained from monitoring feedback into the earlier stages of the machine learning lifecycle 400, particularly data processing 430 and model development 440, to refine the ML model(s) as needed. This iterative process allows a machine learning system to adapt and maintain its alignment with the original business goal 410 over time.

Although a specific embodiment for a machine learning lifecycle 400 suitable for carrying out the various steps, processes, methods, and operations described herein is discussed with respect to FIG. 4, any of a variety of systems and/or processes may be utilized in accordance with embodiments of the disclosure. For example, the particular route of development of the ML model(s) may not follow this machine learning lifecycle 400 completely. As those skilled in the art will recognize, there are a variety of ways to develop AI products that include various iterative steps that aid in development and refinement of different ML models. The elements depicted in FIG. 4 may also be interchangeable with other elements of FIGS. 1-3 and FIGS. 5-12 as required to realize a particularly desired embodiment.

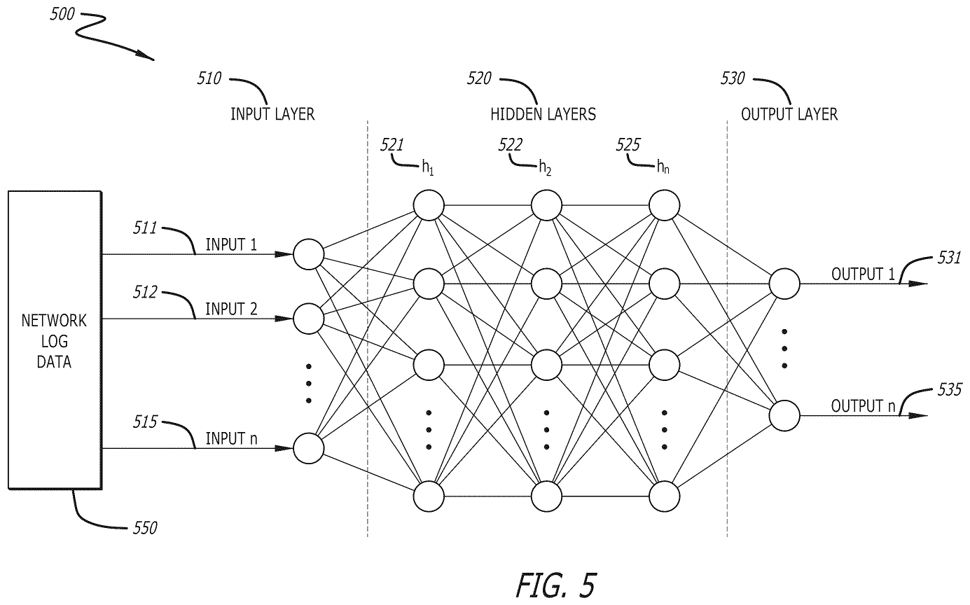

Referring to FIG. 5, a schematic diagram illustrating an example neural network 500 in accordance with various embodiments of the disclosure is shown. The embodiment illustrated in FIG. 5 specifically depicts a feedforward neural network with multiple layers. This type of network includes an input layer 510, one or more hidden layers 520, and an output layer 530. Each layer contains nodes (or neurons) that are interconnected, representing how data flows through the feedforward neural network. The input layer 510 can receive raw network log data 550, which is then processed by the hidden layers 520 through weighted connections and activation functions. These hidden layers 520 can enable the feedforward neural network to learn complex patterns and relationships within the network log data 550.

The final output layer 530 produces predictions or classifications of the feedforward neural network based on the processed network log data. The interconnected nature of the nodes allows the neural network 500 to learn from the network log data 550 during training by adjusting weights of connections to minimize prediction errors. This structure is the foundation of deep learning models, as adding more hidden layers 520 can create a deep neural network, capable of tackling highly complex tasks such as image recognition, NLP, and pattern detection in large datasets.

A perceptron or a single artificial neuron is the building block of ANNs and can perform forward propagation of information. For a set of inputs to the perceptron, weights (and biases to shift weights) can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 500 can be initialized randomly or obtained from a pre-trained model. These weight matrices can be multiplied with the input matrix (or output from a previous layer) and subjected to a nonlinear activation function to yield updated representations, which are often referred to as activations or feature maps. A loss function (also known as an objective function or empirical risk) can often be calculated by comparing the output of the neural network 500 and known target value data.

Feedforward networks, such as the neural network 500 depicted in the embodiment of FIG. 5, are often configured as neural networks where information moves in one direction, from the input layer 510 through the hidden layers 520 to the output layer 530, without any cycles or loops. The feedforward networks are primarily utilized for tasks such as classification, regression, and simple pattern recognition, where each input is processed independently of others. In contrast, backpropagation is not a separate type of network but rather a training algorithm commonly utilized in both feedforward and other types of networks such as Recurrent Neural Networks (RNNs).

Backpropagation involves adjusting the weights of the neural network in a reverse direction (from output to input) based on an error between a predicted output and an actual target during training. While feedforward describes the structure and data flow within the neural network, backpropagation is a technique utilized to optimize the model. Feedforward networks are utilized for straightforward tasks where input-output relationships are not sequential or time-dependent. However, for problems involving learning complex patterns over time, such as speech recognition or time-series analysis, neural networks such as RNNs or deep feedforward networks with many hidden layers, that employ backpropagation for training, may be utilized to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text into categories such as classifying network issues or identifying root causes of the network issues in the network log data 550. The neural network architecture is also useful in regression problems, such as predicting stock prices or energy consumption, where input features can be processed to output continuous values. However, this is a general example of an AI model, illustrating how a feedforward neural network works. Depending on the problem, other methods and models may be more appropriate. For example, CNNs are often utilized for image processing tasks, while RNNs are suitable for sequential data such as time series data or text. Additionally, simpler models such as linear regression, decision trees, or SVMs may be sufficient if the problem is less complex, or a dataset is relatively small. The embodiment depicted in FIG. 5 is presented as an example ML solution that may be deployed within one or more methods or systems described herein.

In a number of embodiments, the input layer 510 is the first layer in the neural network 500 and serves as the initial point where raw network log data 550 is introduced into the model. Each node (or neuron) in this input layer 510 represents an individual feature or variable from the dataset, allowing the neural network 500 to receive and process various types of data, such as features in the network log data 550, pixel values in an image, numerical features in a spreadsheet, or words in a text document. For instance, in image recognition tasks, the input layer 510 can include nodes that correspond to pixel values of the image, providing the neural network 500 with visual information needed to identify objects or patterns. The number of nodes in the input layer 510 directly depends on the number of features present in the dataset. If there are one hundred features in the network log data 550, the input layer 510 may typically have one hundred nodes, each conveying one piece of the information to the subsequent layers. In a variety of embodiments, the inputs of the neural network 500 are generally scaled, that is, normalized to have a zero mean and/or a unit standard deviation. Scaling can also be applied to the input of the hidden layers 520, for example, by utilizing batch or layer normalization to improve the stability of the neural network 500.

Unlike the hidden layers 520 and the output layer 530, the input layer 510 typically does not perform any computations or transformations on the data. The primary function of the input layer 510 is often to pass the input data to the next layer in the neural network 500, that is, the first hidden layer 521. However, it is often desired that the data fed into this first hidden layer 521 is preprocessed appropriately, such as being normalized or standardized, to ensure that the neural network 500 can learn efficiently. Proper preprocessing, for example, scaling numerical values or encoding categorical variables, can help the neural network 500 process data uniformly, facilitating more stable and faster convergence during training.

The design of the input layer 510 depends on the nature of the problem. For example, in NLP, the input layer 510 may represent words encoded as numerical vectors, while in time series analysis, each node may represent a data point in a sequence. While the input layer 510 itself does not modify the data, the input layer 510 sets the stage for the neural network 500 to extract complex patterns and relationships through the deeper layers. This flexibility in handling various types of input make the neural network 500 a powerful tool for a diverse set of applications.

With respect to the embodiments described herein, the input layer 510 may be configured with a plurality of inputs providing network log data 550. For example, the ML model can be configured with a first input 511 configured as IP addresses, a second input 512 configured with event type, while additional inputs can be added related to temporal characteristics associated with the network log data 550. The nth input 515 can be configured in various embodiments to include connection attempts and failures associated with network devices. However, as those skilled in the art will recognize, additional setups can be configured such that the inputs 511, 512, and 515 can be configured to also include different parameters such as latency, packet loss, bandwidth usage, connection statuses, one or more port numbers, packet sizes, one or more protocol types, one or more timestamps, one or more bytes of a payload, error rates, weights, etc.

In more embodiments, the neural network 500 comprises a plurality of hidden layers 520. The embodiment depicted in FIG. 5 comprises a first hidden layer 521, a second hidden layer 522, and an nth hidden layer 525, which are denoted as h₁, h₂, and hₙ, respectively. In additional embodiments, the hidden layers 520 are disposed where the core of the ML model's learning and pattern recognition occurs. In each of the hidden layers 520, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the neural network 500 to capture complex patterns in the data that simple linear models cannot. The intricate web of connections among neurons across layers helps the neural network 500 transform and process input features into representations that become progressively more abstract and useful for making predictions.

The first hidden layer 521, h₁, receives direct input from the input layer 510, transforming the raw network log data 550 into an initial set of features. For example, in a network diagnostics task, the first hidden layer 521 may initiate differentiating between normal network behavior and behavior that indicates performance degradation or unusual traffic patterns. The output of the first hidden layer 521 is then passed to the second hidden layer 522, h₂, which builds upon the features identified by the first hidden layer 521. This deeper second hidden layer 522 may start recognizing more complex patterns, for example, specific correlations between packet loss, high latency, and device configurations that identify a routing issue, unusual traffic patterns or failed connection attempts across multiple network devices, which may indicate a Distributed Denial-of-Service (DDoS) attack or unauthorized access attempts, or the like, by combining the lower-level features identified in the previous hidden layer. This can continue until a last, nth hidden layer 525, hₙ, continues this abstraction process, allowing the neural network 500 to recognize even higher-level, more detailed features, such as identifying a combination of multiple protocol transitions over time that indicate a multi-stage attack, for example, Man-in-the-Middle (MitM) attacks, Advanced Persistent Threats (APTs), or the like, combining high latency, packet loss, and error rates to deduce that a misconfigured router is likely causing a network slowdown, or understanding intricate relationships in the input network log data 550. With respect to the embodiments described herein, the hidden layers 520 may learn one or more patterns of the input network log data 550 to extract higher-level features from the raw network log data 550, thereby improving the ability of the ML model to identify the root causes of the network issues.

Each of the hidden layers 520 adds a level of complexity and abstraction to the learning capabilities of the neural network 500. The multi-layer structure can enable the neural network 500 to move from recognizing simple patterns in the first hidden layer 521 to highly complex, abstract concepts in the deeper hidden layers. The number of hidden layers 520 and neurons within them can vary depending on the complexity of the problem. More hidden layers 520 generally allow the neural network 500 to model more intricate functions, making deep neural networks especially effective for tasks such as image recognition, NLP, root cause identification, anomaly detection, and complex predictive modeling. However, adding more layers also increases the computational demand and the risk of overfitting, highlighting the need to carefully design and tune these hidden layers 520 for optimal performance.

In further embodiments, the output layer 530 is often the final layer in the neural network 500 and is responsible for producing predictions or classifications of the neural network 500 based on the information processed through the previous hidden layers 520. Each neuron in the output layer 530 can represent a specific outcome or category that the ML model can predict. In the embodiment depicted in FIG. 5, the outputs are labeled as “output 1” 531 to “output n” 535, indicating that the neural network 500 can be designed to have a varying number of outputs depending on the nature of the problem being solved. For example, in a binary classification (e.g., normal events versus anomalous events), there would typically be a single output neuron that provides a probability score for one of the two classes/outcomes. In contrast, for multi-class classification (e.g., categorizing network events into different types based on protocols utilized in communications), the output layer 530 would contain multiple neurons, each corresponding to a different class.

The number of neurons in the output layer 530 can also be designed specifically for other types of tasks, such as regression, where the ML model can predict continuous values. In such cases, the output layer 530 may contain a single neuron representing a numerical prediction, such as a price of a house or a temperature forecast, etc. Alternatively, in complex applications such as multi-label classification (where each input can belong to multiple classes simultaneously), the output layer 530 could have multiple neurons, each representing a different class, with each neuron outputting a probability of the input belonging to that specific class.

The activation function utilized in the output layer 530 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 530 allows the neural network 500 to be applied to a wide variety of tasks, from simple binary decisions to complex multi-output predictions, making them a versatile tool in artificial intelligence and machine learning.

Although a specific embodiment for an example neural network 500 suitable for carrying out the various steps, processes, methods, and operations described herein is discussed with respect to FIG. 5, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 5, which is an illustrative example that explains the basic concepts of neural networks and how they process information. The specific features and functions described herein are not intended to be limiting to this specific embodiment. The elements depicted in FIG. 5 may also be interchangeable with other elements of FIGS. 1-4 and FIGS. 6-12 as required to realize a particularly desired embodiment.

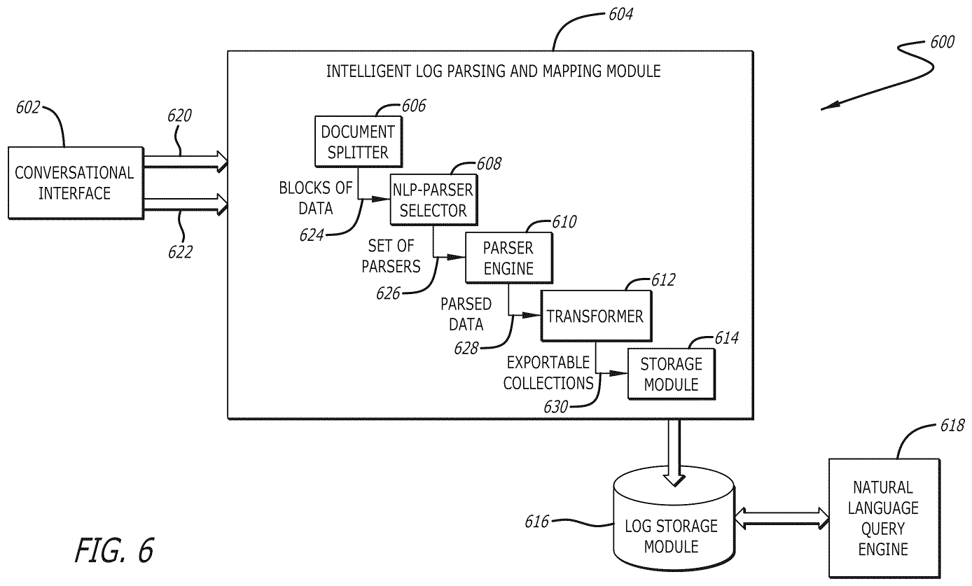

Referring to FIG. 6, a block diagram illustrating a context-aware, AI-driven Network Diagnostics and Troubleshooting (NDT) system 600 in accordance with various embodiments of the disclosure is shown. In many embodiments, by integrating advanced technologies such as Natural Language Processing (NLP), AI, ML, fuzzy logic, and advanced indexing, the AI-driven NDT system 600 disclosed herein may automate the analysis of complex network logs. This automation may not only save time with increased productivity and better quality, but may also increase accuracy in identifying and resolving network issues. In a number of embodiments, the AI-driven NDT system 600 may include a conversational interface 602, an Intelligent Log Parsing and Mapping (ILPM) module 604, a log storage module 616, and a natural language query engine 618 as illustrated in FIG. 6. The conversational interface 602 may allow users, for example, network engineers, network administrators, developers, technicians, teams, partners, technical assistance centers, or the like, to query the network logs using a natural language, thereby increasing accessibility of the AI-driven NDT system 600 to a wide range of users. In a variety of embodiments, the AI-driven NDT system 600 may implement collaborative features to allow teams, for example, support teams, engineering teams, quality assurance teams, escalation teams, or the like to work together seamlessly, sharing insights and accelerating problem-solving.

In various embodiments, the AI-driven NDT system 600 may employ network logs generated by multiple network devices, for example, show tech logs, to provide recommendations including actionable recommendations for resolving device scope or network wide issues. Show tech logs may refer to technical support logs obtained by running a show tech command (sh tech), also referred to as a “show tech-support” command. The show tech command may display diagnostic information for technical support, for example, on a Command Line Interface (CLI), by running relevant or all show commands on hardware, for example, on the network devices. The network logs may be of different formats and received from various sources. In more embodiments, the AI-driven NDT system 600 may process detailed network log data about network device features, for example, switch features, received from the network logs by automatically running some or all show commands associated with the network device features. In additional embodiments, the AI-driven NDT system 600 may be configured to automate ingestion and analysis of voluminous network log data, for example, “show tech” data, generated by multiple network devices.

In further embodiments, the ILPM module 604 of the AI-driven NDT system 600 may process network logs by utilizing NLP. In still more embodiments, the ILPM module 604 may receive one or more network logs including the network log data, from user devices via the conversational interface 602. For example, a user may input technical support logs 620 and switch details 622 for exporting the technical support logs to the ILPM module 604 via the conversational interface 602. The ILPM module 604 may implement a data mining process to parse and extract, for example, CLI output including the network log data received through the conversational interface 602, focusing on Key Performance Indicators (KPIs) and error logs, thereby substantially reducing data redundancy and noise. In still further embodiments, the ILPM module 604 may normalize the extracted network log data into a structured format, for example, a JavaScript Object Notation (JSON) format, for optimal storage and querying. In still additional embodiments, the ILPM module 604 may subsequently import the normalized network log data into a database, for example, a scalable Not Only Structured Query Language (NoSQL) database such as the mongoDB® document database of MongoDB, Inc., allowing rapid retrieval and complex analytics of the network log data. The ILPM module 604 may organize the normalized network log data into a structured dictionary within the mongoDB® document database, thereby enabling the execution of SQL queries for efficient troubleshooting and data retrieval. The ILPM module 604 may implement an SQL wrapper over the mongoDB® document database that provides an SQL-like interface to interact with the mongoDB® document database. By streamlining a data pipeline and optimizing data storage, the AI-driven NDT system 600 may substantially accelerate context-aware network diagnostics including root cause analysis, and troubleshooting. This data-driven approach implemented in the AI-driven NDT system 600 may empower the users to identify and resolve network issues more swiftly and accurately.

In an exemplary implementation of the AI-driven NDT system 600, the ILPM module 604 may include a document splitter 606, an NLP-parser selector 608, a parser engine 610, a transformer 612, and a storage module 614. The document splitter 606 may receive the network log data from the user input including, for example, the technical support logs 620 and the switch details 622, and split or divide large text documents in the network log data into smaller, manageable blocks of data 624, to improve processing speed, accuracy, and scalability of NLP tasks. The document splitter 606 may consider semantic boundaries, contextual information, and a specific NLP task during splitting of the large text documents in the network log data. The splitting of the large text documents in the network log data may optimize NLP models for better performance and insights.

The NLP-parser selector 608 may receive the blocks of data 624 from the document splitter 606. In some more embodiments, the NLP-parser selector 608 may intelligently select an appropriate set of NLP parsers 626 based on content of a given text document, thereby substantially enhancing the accuracy and efficiency of NLP tasks. The NLP parser may refer to a tool or an algorithm configured to analyze and interpret a structure of a sentence or text in a natural language. The NLP parser may utilize syntactic analysis to break down the sentence into its components and interpret their relation to each other, thereby identifying grammatical structures and dependencies between words in the sentence. In yet various embodiments, the NLP-parser selector 608 may create a database or a configuration file defining various parser objects. Each of the parser objects may be associated with specific token patterns or sequences. The NLP-parser selector 608 may invoke the selected NLP parser when these token patterns or sequences match with the blocks of data 624. In yet more embodiments, the NLP-parser selector 608 may define hierarchical selection criteria configured to establish a hierarchy of rules, allowing for more granular filtering of the network log data. The hierarchy of rules may include, for example, broad-level rules and specific rules. The broad-level rules may define matching of general patterns for selecting a broad category of NLP parsers. The specific rules may define matching of more precise patterns for selecting a specific NLP parser within a category. In still yet more embodiments, the NLP-parser selector 608 may implement parser chain selection including defining chains of tokens that must be present to trigger a specific NLP parser, allowing for complex pattern matching and context-aware selection of the NLP parser. In many further embodiments, the NLP-parser selector 608 may execute a customizable NLP algorithm that provides flexibility and adaptability. The NLP-parser selector 608 may allow the users to finetune the selection of the NLP parser by adjusting the NLP algorithm to prioritize specific criteria or rules. In many additional embodiments, the NLP-parser selector 608 may train the NLP algorithm on custom data, for example, specific network device commands associated with a network operating system, to improve accuracy of the NLP algorithm. In still yet further embodiments, the NLP algorithm may be configured to adapt to evolving network environments, thereby keeping the AI-driven NDT system 600 up to date with changing network technologies and configurations. By utilizing NLP to dynamically select the appropriate NLP parser for each block of data 624, the AI-driven NDT system 600 can adapt to different network device configurations and diverse output data formats, select the most suitable NLP parser for each specific data type, thereby improving parsing accuracy, and minimize the need for manual configuration and tuning.

The parser engine 610 may receive the selected set of NLP parsers 626 from the NLP-parser selector 608. In still yet additional embodiments, the parser engine 610 may automatically ingest the blocks of data 624 received from the document splitter 606. In several embodiments, the parser engine 610 may receive the network logs of different formats, for example, the JSON format, an extensible Markup Language (XML) format, a Comma-Separated Values (CSV) format, or another proprietary format specific to a network device, from various sources. In several more embodiments, the parser engine 610 may identify and extract relevant network log data including, for example, timestamps, error codes, user activity, or the like. In numerous embodiments, the parser engine 610 may convert unstructured network log data into a structured format. In numerous additional embodiments, the parser engine 610 may represent a single block of data 624 as a cluster in the structured format. In further additional embodiments, the parser engine 610 may organize the extracted network log data into structured key-value pairs for storage and indexing. In many embodiments, the parser engine 610 may create a searchable index to implement quick and precise queries on the parsed network log data. In a number of embodiments, the parser engine 610 may parse the user input, apply fuzzy logic, and map keywords to show commands. The parser engine 610 may tokenize the user input, remove stop words, and apply fuzzy matching to match user terms to show commands. The parser engine 610 may then map commands, for example, using a Yet Another Markup Language (YAML) file and generate a query, for example, a mongoDB® query. By utilizing the parser engine 610, the AI-driven NDT system 600 may allow the users to quickly find specific information within large volumes of the network log data, facilitating faster troubleshooting and resolution of the network issues.

The transformer 612 may receive the parsed network log data 628 from the parser engine 610. The transformer 612 may render an interface to normalize the parsed network log data 628 generated by the parser engine 610. In a variety of embodiments, the transformer 612 may assist in creating a uniform data format for the network log data, thereby optimizing a search by query for the next steps in the data pipeline. For example, if the network log data from two different routers utilize different timestamp formats or units such as a UNIX timestamp versus a human-readable time, the transformer 612 may normalize the network log data into a single, consistent data format such as the International Organization for Standardization (ISO) 8601 format for timestamps. In various embodiments, the transformer 612 may output structured sets of network log data as exportable collections 630 to the storage module 614. In more embodiments, the storage module 614 may store the exportable collections 630 and provide an interface for retrieving the network log data. In additional embodiments, the storage module 614 may be operably coupled to the log storage module 616 of the AI-driven NDT system 600. The natural language query engine 618 of the AI-driven NDT system 600 may be in operable communication with the log storage module 616 and may allow the users to retrieve the network log data through a search by query into the log storage module 616. In various embodiments, the natural language query engine 618 may render an NLP-driven query interface for receiving queries from the users. The log storage module 616 may retrieve the queried network log data from the storage module 614 of the ILPM module 604, store the retrieved network log data, and render the retrieved network log data to the users via the natural language query engine 618. In further embodiments, the users may view the retrieved network log data on the conversational interface 602 of the AI-driven NDT system 600.

Although a specific embodiment for a context-aware, AI-driven NDT system 600 suitable for carrying out the various steps, processes, methods, and operations described herein is discussed with respect to FIG. 6, any of a variety of systems and/or processes may be utilized in accordance with embodiments of the disclosure. For example, instead of show tech logs, the ILPM module 604 may ingest, split, parse, and transform other logs such as system logs that capture system events, errors, and status updates, access logs, firewall logs, flow logs, intrusion detection logs, or the like, for network diagnostics and troubleshooting. The elements depicted in FIG. 6 may also be interchangeable with other elements of FIGS. 1-5 and FIGS. 7-12 as required to realize a particularly desired embodiment.

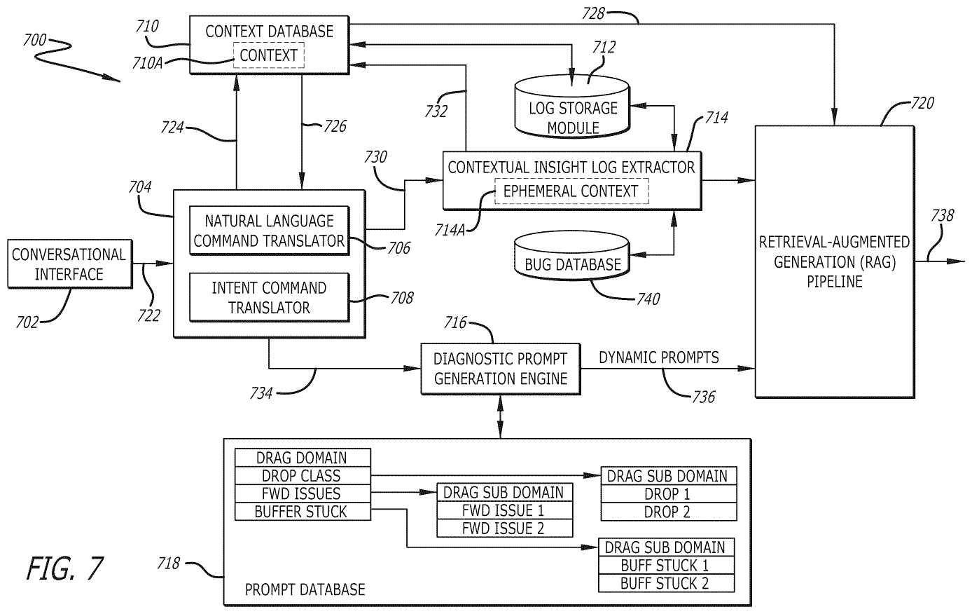

Referring to FIG. 7, a block diagram illustrating a natural language query engine 700 for context-aware, AI-driven network diagnostics and troubleshooting in accordance with various embodiments of the disclosure is shown. In many embodiments, the natural language query engine 700 may be configured as an NLP-driven query interface module to transform user-provided natural language queries into structured, machine-interpretable queries. In a number of embodiments, the natural language query engine 700 may employ advanced NLP techniques to extract at least one diagnostic context, intent, and user characteristics from a user's input query 722. The natural language query engine 700 may then utilize the extracted information to generate a set of predefined queries tailored to a specific user's needs. The natural language query engine 700 may execute the generated set of queries against a normalized logs database, herein referred to as a “log storage module 712”, providing accurate results. In a variety of embodiments, the natural language query engine 700 may generate a prompt template customized to the user's input query 722, enhancing user experience and enabling more precise and relevant interactions with the natural language query engine 700.

In an exemplary implementation illustrated in FIG. 7, the natural language query engine 700 may include translators 704, a context database 710, a contextual insight log extractor 714, a diagnostic prompt generation engine 716, a prompt database 718, and a filter pipeline 720. The user may access the natural language query engine 700 via a conversational interface 702. For example, the user may input query parameters such as a time range, triage context information, and user messages, associated with a network issue into the natural language query engine 700 via the conversational interface 702. The time range may allow the natural language query engine 700 to identify when the network issue occurred. The triage context information may refer to specific information utilized during a triage process for network diagnostics and troubleshooting. The triage context information may include, for example, error messages, network log data, timestamps, system performance metrics, severity of network issues such as critical, high, medium, and low, or the like. In various embodiments, the conversational interface 702 may be an NLP interface configured to remove stop words and apply fuzzy logic, translating the user's queries into network-specific commands and dynamically querying the network log data along with deriving intent from the queries.

In more embodiments, the translators 704 may include a natural language command translator 706 and an intent command translator 708. The natural language command translator 706 may refer to an NLP system configured to interpret user-provided natural language commands and translate the natural language commands into specific commands compatible with a Network Operating System (NOS). A command may refer to a direct instruction or order to perform a specific action. The natural language command translator 706 may employ a knowledge base of NOS-specific meta-information to map well-known networking concepts to underlying NOS commands. The natural language command translator 706 may employ iterative filtering and mapping operations to accurately translate the user's intent into executable commands. In various embodiments, the executable commands may be utilized to extract relevant network log data to be fed into the filter pipeline 720. In additional embodiments, the knowledge base may be version-controlled to ensure compatibility with evolving NOS versions and configurations, enabling the natural language command translator 706 to adapt to changing network environments. The intent command translator 708 may refer to an advanced NLP system configured to accurately interpret the user's intent from a sequence of natural language queries. By employing advanced techniques in contextual understanding, the intent command translator 708 may analyze an intricate relationship between multiple natural language queries, even when an explicit intent is not directly stated. The intent command translator 708 may analyze contextual cues including, for example, an indication of a specific network device or system in question and an ongoing dialogue between the user and the natural language query engine 700 via the conversational interface 702. By analyzing these contextual cues, the intent command translator 708 may identify underlying patterns and infer the user's intent, thereby allowing the natural language query engine 700 to provide highly accurate and relevant responses, substantially enhancing the user experience, and boosting overall productivity.

In further embodiments, the context database 710 may refer to a knowledge base configured to analyze user interactions with a log storage module 712 to derive insights into the user's intent and context. In still more embodiments, the context database 710 may organize the user interactions into a set of executable queries that can be applied to any log database. By segmenting user sessions into multiple contexts, the context database 710 may identify various potential interpretations and unlock valuable insights. In still further embodiments, the context database 710 may also track an evolving intent of the user throughout a user session, enabling more accurate and relevant responses. In still additional embodiments, the context database 710 may capture a user-specific context, allowing for personalized interactions tailored to individual user preferences and behaviors. The natural language query engine 700 may implement a hierarchical organization of user context and intent information in the context database 710 for optimal retrieval and analysis, leading to improved user experience and productivity. The context database 710 may store the intent, insights, and the context as “diagnostic context” denoted as “context 710A” in FIG. 7. In some more embodiments, the context database 710 may operate as a knowledge sharing platform that may allow the user to label and organize troubleshooting command sets which are accessible to other users in the AI-driven NDT system.

In yet various embodiments, the contextual insight log extractor 714, in operable communication with the log storage module 712, may be configured to enhance NLP workflows. By tracking and analyzing each NLP interaction within the user session, the contextual insight log extractor 714 may provide insights into the performance and optimization potential of NLP pipelines. In yet more embodiments, the contextual insight log extractor 714 may perform session logging and model versioning. For example, the contextual insight log extractor 714 may log each NLP interaction including timestamps, user inputs, model outputs, and model configurations. In still yet more embodiments, the contextual insight log extractor 714 may diagnose a network issue as a sequence of NLP tasks. The contextual insight log extractor 714 may conceptualize a diagnosis as a structured sequence of NLP tasks, allowing granular analysis and optimization. In many further embodiments, the contextual insight log extractor 714 may identify potential inefficiencies including, for example, redundant steps or suboptimal model choices, in suboptimal workflows.

In many additional embodiments, the contextual insight log extractor 714 may allow users to review and edit an executed workflow, for example, by way of reordering tasks, substituting models, or modifying prompts to optimize the executed workflow, thereby implementing user-driven workflow optimization. A prompt may refer to a request for input, often asking the user to provide some information, response, or action. Prompts may be utilized in interactive settings where user interactions are performed via the conversational interface 702 and where the AI-driven NDT system may expect the user to provide additional user input. Prompts may be open-ended and can be phrased as a question or a statement encouraging the user to engage in a dialogue. In still yet further embodiments, through AI-assisted workflow optimization, the contextual insight log extractor 714 may proactively suggest potential optimizations by utilizing advanced techniques to reduce a prompt count, minimize latency, and enhance accuracy. In still yet additional embodiments, the contextual insight log extractor 714 may implement contextual knowledge sharing, allowing users to save and publish optimized diagnostic workflows to a community repository, fostering knowledge sharing and collaboration. In several embodiments, the contextual insight log extractor 714 may associate each diagnostic context with metadata, facilitating optimal management, search, and retrieval. The contextual insight log extractor 714 may streamline the NLP workflows, improve the quality of diagnostic outputs, and accelerate provisioning of insights. In several more embodiments, the insights, potential inefficiencies, potential optimizations, and the diagnostic context with metadata generated by the contextual insight log extractor 714 may be temporary, short-lived, or transient in nature and referred to as “ephemeral context 714A”, thereby existing for only a brief period for the user session without persisting over time. In numerous embodiments, the insights, potential inefficiencies, potential optimizations, and the diagnostic context with metadata generated by the contextual insight log extractor 714 may be stored in the context database 710 as the context 710A.

In numerous additional embodiments, the diagnostic prompt generation engine 716 may include a repository of various prompts that may be represented as signatures of individual network issues for a given operating system. The diagnostic prompt generation engine 716 may construct these prompts in a hierarchy and store these prompts as a graph in the prompt database 718. The diagnostic prompt generation engine 716 may extract the user's intent along with context and a contextual log from the user's input query 722. The diagnostic prompt generation engine 716 may map the intent to a corresponding diagnostics domain arranged in a predefined hierarchical manner and utilize the intent to generate on-demand prompts, also referred to as “dynamic prompts 736”, in communication with the prompt database 718. The contextual insight log extractor 714 and the diagnostic prompt generation engine 716 may together constitute an analytics engine for context-aware, AI-driven network diagnostics and trouble shooting.

In further additional embodiments, the natural language query engine 700 may employ GNNs to perform a graph-based casual analysis and infer causal dependencies between network components, error types, and messages, allowing the identification of root causes of the network issues across disparate network devices and network components. The natural language query engine 700 may analyze causal relationships between log events using a GNN to infer causal dependencies and pinpoint root causes across distributed components. In many embodiments, the natural language query engine 700 may utilize the GNNs to model the network as a graph, where nodes represent network components, error types, log types, or messages, and edges denote relationships or dependencies between the nodes. By iteratively propagating information along the edges, the GNNs may learn latent representations that capture both local and global dependencies within the network. In a number of embodiments, through causal inference techniques, the GNNs may identify causal relationships between the nodes or error crumbs in logs from various components, allowing the natural language query engine 700 to identify the root causes of the network issues and predict potential future network issues. In a variety of embodiments, the natural language query engine 700 may utilize the GNNs to correlate the network issues and identify interdependent network issues across multiple components, subsystems, or network devices, assisting in root cause analysis. Further, in various embodiments, the natural language query engine 700 may utilize the GNNs to infer and highlight causal relationships, improving root cause accuracy in complex environments.

In more embodiments, the natural language query engine 700 may implement meta-learning for rapid adaptation to emerging or previously unclassified error patterns. In additional embodiments, the natural language query engine 700 may employ a meta-learning system that implements, for example, Model-Agnostic Meta-Learning (MAML) to quickly learn and adapt to previously unclassified error patterns with minimal data, allowing the natural language query engine 700 to generalize and identify new error patterns even with limited examples, thereby enhancing troubleshooting accuracy in dynamic network environments. Meta-learning may enhance the ability of the natural language query engine 700 to handle new or emerging network issues, which may be helpful in dynamic network environments where new types of errors may arise due to configuration or hardware changes or where new software features may be added to a code base. The meta-learning system may also learn from the user input based on the feedback received from the conversational interface 702.

In further embodiments, the natural language query engine 700 may communicate with a parser engine of an ILPM module of the AI-driven NDT system. The parser engine may execute time-ordered log parsing, for example, with Finite State Machine (FSM) and Inter-Process Communication (IPC) message tracking. In still more embodiments, a document splitter of the ILPM module may segment and organize the logs by timestamp, allowing time-based filtering and categorization by component. In still further embodiments, the parser engine may segment and organize the logs by timestamp. The natural language query engine 700 may track FSM and IPC messages of each component in the network, allowing the users to retrieve the logs from the log storage module 712 by time range or by component list. This organization of the logs may allow the users to quickly access the logs relevant to a specific time or component, allowing focused diagnostics and isolation of a network issue across a distributed system. Further, this organization of the logs by timestamp and component may allow the users to isolate relevant logs by the list of components or subsystems and a time range.

In still additional embodiments, the natural language query engine 700 may implement reinforcement learning for query optimization, performance tuning, and user guidance to improve the relevance of log responses over time. The natural language query engine 700 may optimize natural language queries based on user interactions, while adjusting the responses of the natural language query engine 700 based on feedback. The natural language query engine 700 may employ reinforcement learning to refine and optimize responses to the user's queries by learning from the user's feedback, improving log retrieval accuracy over time. The reinforcement learning-based approach may dynamically adjust log prioritization and query handling, increasing the responsiveness of the natural language query engine 700 and relevance by applying positive or negative feedback from user interactions.

In some more embodiments, the natural language query engine 700 may employ a Reinforcement Learning (RL) agent configured to implement reinforcement learning with Q-learning. The natural language query engine 700 may define the user's queries as actions and log segments as states. The RL agent may be awarded positive rewards when responses of the RL agent are pertinent and helpful, and negative rewards when the responses are not. Over time, the RL agent may adapt by identifying which log sections or commands to prioritize based on the user's feedback patterns, thereby optimizing response accuracy and relevance. The RL agent may learn to select optimal network log data segments, sections, or commands for response generation based on state-action pairs, thereby improving user experience and query precision as the RL agent adapts to the user's feedback patterns. The RL agent may continually adapt to provide more accurate, relevant information based on accumulated user interactions, enhancing the responsiveness of the natural language query engine 700 and user satisfaction.

In yet various embodiments, the natural language query engine 700 may implement an attention mechanism, for example, self-attention or transformer-based attention, for log prioritization and inference. The attention mechanism may identify and prioritize the most relevant sections of the logs, particularly when analyzing large log files with multiple error messages and log types. The natural language query engine 700 may utilize the attention mechanism to analyze each error log entry in relation to the others, assigning attention scores based on relevance to the user's current input query or network issue. The attention mechanism may assign relevance scores to each error log entry, contingent on the user's queries or known network issues, thereby facilitating dynamic prioritization of network log data. For example, if a port is error disabled, there may be more than few components involved. These components may include, for example, a Software Development Kit (SDK), a driver, port-client, ethpm, if-manager, or the like. The attention mechanism may assist in reasoning the relevant related errors logs to infer a given network issue. The error for a given interface from all these components may need to be stitched or analyzed to infer that that port is error disabled. The attention mechanism may prioritize high-scoring log entries, allowing the natural language query engine 700 to focus on the most relevant portions of the logs for faster response and improved troubleshooting accuracy. The attention mechanism may allow the natural language query engine 700 to reduce the amount of network log data users need to review by highlighting and displaying the most critical error log entries, improving efficiency and focus during network diagnostics and troubleshooting. In yet more embodiments, the attention mechanism may include a self-attention model configured to analyze each error log entry in relation to others, prioritizing those most relevant to the network issue being queried, allowing the user to focus on high-priority log entries. In still yet more embodiments, the natural language query engine 700 may employ a method for highlighting critical error log entries in a way that reduces data overload and enhances root cause analysis by ranking the log entries according to attention scores computed from patterns of relevance and intent.

In many further embodiments, the natural language query engine 700 may perform targeted log summarization with Retrieval-Augmented Generation (RAG). RAG may refer to an AI framework or technique for enhancing the accuracy and reliability of generative AI models, for example, generative Large Language Models (LLMs), with information fetched from specific and relevant data sources. In the embodiments herein, the RAG framework may utilize search algorithms to query and retrieve external network log data, for example, from system logs, webpages, knowledge bases, databases, or the like. The search algorithms may utilize vector databases to retrieve relevant network log data. The vector databases may store documents as embeddings in a high-dimensional space, allowing for fast and accurate retrieval of the network log data based on semantic similarity. Once retrieved, the external network log data may undergo preprocessing including, for example, tokenization, stemming, and removal of stop words. The RAG framework may then feed the preprocessed network log data into a pretrained LLM, which may augment the LLM's context, providing the LLM with a more comprehensive understanding of the network issues. This augmented context may allow the LLM to generate more precise, informative, and engaging responses to the user's queries.

The natural language query engine 700 may employs the RAG pipeline 720 to extract and render relevant network log data segments in response to user queries, creating targeted summaries that are concise and contextually accurate using the diagnostic context disclosed above. The natural language query engine 700 may utilize RAG to filter and pre-process large volumes of network log data based on known issue types, providing a focused prompt to the LLM that minimizes unnecessary information and maximizes response precision. The natural language query engine 700 may enhance LLM responses by applying retrieval-based selection of the network log data and constructing a prompt template that aligns with the queried network issue, thereby reducing hallucination and improving summarization accuracy. The natural language query engine 700 may improve the accuracy of the LLM responses by presenting only relevant network log data through a targeted prompt template.

The natural language query engine 700 may filter the network log data to include only relevant network log data segments related to the network issue, based on keyword and semantic matches. The natural language query engine 700 may then select an appropriate prompt template, for example, for packet drops, link failures, or the like, and utilize a RAG API to input structured network log data into the LLM. The LLM may generate a response based on the focused network log data, providing an accurate summary without unnecessary information. The natural language query engine 700 may, therefore, reduce data processing load and improve the precision of LLM outputs, minimizing hallucination and optimizing the troubleshooting process.

In many additional embodiments, the natural language query engine 700 may receive an input query 722 via the conversational interface 702 and execute a data pipeline. The data pipeline may include, for example, the context database 710 and the contextual insight log extractor 714. In still yet further embodiments, the natural language query engine 700 may utilize the context 710A stored in the context database 710 and the ephemeral context 714A generated by the contextual insight log extractor 714 to create one or more vector databases on-demand for a current user session. The natural language query engine 700 may then utilize the dynamic prompts 736 generated by the diagnostic prompt generation engine 716 along with the created vector database(s) to execute the filter pipeline 720 to infer the network issues through AI-based inferencing. In still yet additional embodiments, the filter pipeline 720 may be a RAG pipeline and may herein be referred to as the “RAG pipeline 720.”

In several embodiments, the RAG pipeline 720 may receive query parameters from the user's input query 722 via the conversational interface 702, the dynamic prompts 736 from the diagnostic prompt generation engine 716, the ephemeral context 714A from the contextual insight log extractor 714, and the context 710A from the context database 710 as input to provide an output 738 including AI-based reasoning about the network issues and their root causes. By rendering only the most relevant network log data based on the input to the LLM in the RAG pipeline 720 with customized dynamic prompts 736, the natural language query engine 700 may enhance relevance of the dynamic prompts 736, thereby improving response accuracy and reducing computational overhead.

Consider an example where the natural language query engine 700 receives an input query 722 including query parameters such as a time range, triage context information, and a user message, from a user such as a network administrator via the conversational interface 702. The natural language command translator 706 may receive the user's input query 722 via the conversational interface 702 and interpret and translate the user's input query 722 into specific commands compatible with an NOS. The natural language command translator 706 may employ a knowledge base of NOS-specific meta-information to map well-known networking concepts to underlying NOS commands. The natural language command translator 706 may employ iterative filtering and mapping operations to identify the user's intent and accurately translate the user's intent into executable commands. In this example, the natural language command translator 706 may normalize the user message and render the normalized user message and the identified intent as parameters 724 to the context database 710. The natural language command translator 706 may communicate with the context database 710 to derive at least one diagnostic context based on the normalized user message and the identified intent. In several more embodiments, if the diagnostic context(s) corresponding to the normalized user message and the identified intent is found in the context database 710, the context database 710 may feed pre-populated queries 728 associated with the diagnostic context(s) to the RAG pipeline 720. If there is no diagnostic context(s) corresponding to the normalized user message and the identified intent in the context database 710, the context database 710 may transmit a “no context found” message 726 to the natural language command translator 706.

The natural language command translator 706, in operable communication with the contextual insight log extractor 714, may then interact with the user via the conversational interface 702 in the ongoing user session to develop the diagnostic context. By tracking and analyzing each NLP interaction 730 within the user session, the contextual insight log extractor 714 may provide insights into the performance and optimization potential of NLP pipelines. In numerous embodiments, the contextual insight log extractor 714 may perform session logging and model versioning. For example, the contextual insight log extractor 714 may log each NLP interaction 730 including timestamps, user inputs, model outputs, and model configurations. In numerous additional embodiments, the contextual insight log extractor 714 may diagnose a network issue as a sequence of NLP tasks. The contextual insight log extractor 714 may conceptualize a diagnosis of the network issue as a structured sequence of NLP tasks. The contextual insight log extractor 714 may, therefore, derive at least one diagnostic context based on the NLP interactions 730. In further additional embodiments, the contextual insight log extractor 714 may associate each diagnostic context with metadata and store the diagnostic context(s) with the metadata 732 in the context database 710. In many embodiments, the contextual insight log extractor 714 may derive network topologies from stored or received logs and automatically zoom on the time range of the logs, thereby focusing log analysis within calculated or user-provided time ranges. In a number of embodiments, the contextual insight log extractor 714 may also store outputs of the session logging in the log storage module 712, which may in turn, communicate the outputs to the context database 710. The contextual insight log extractor 714 may feed the diagnostic context(s) to the RAG pipeline 720.

The intent command translator 708 may interpret the user's intent from a sequence of natural language queries via the conversational interface 702. In this example, the intent command translator 708 may receive the query parameters from the user's input query 722. From the query parameters, the intent command translator 708 may analyze contextual cues including, for example, an indication of a specific network device or system in question and an ongoing dialogue between the user and the natural language query engine 700 via the conversational interface 702. By analyzing these contextual cues, the intent command translator 708 may identify underlying patterns and infer the user's intent. By automatically zooming on the time range of the logs and correlating with the intent, the natural language query engine 700 may zoom on, for example, a 30-second range or a 20-second range of the network issue that the user is trying to solve. In a variety of embodiments, the intent command translator 708 may render the inferred intent and contextual metadata as parameters 734 to the diagnostic prompt generation engine 716. In various embodiments, the diagnostic prompt generation engine 716 may include a repository of various prompts that may be represented as signatures of individual network issues for a given operating system. The diagnostic prompt generation engine 716 may construct these prompts in a hierarchy and store these prompts as a graph in the prompt database 718. The prompt database 718 may store diagnostic domains and subdomains associated with the network issues, for example, drop class, forwarding issues, buffer stuck, or the like. The diagnostic prompt generation engine 716 may extract the user's intent along with context and a contextual log from the user's input query. The diagnostic prompt generation engine 716 may map the intent to a corresponding diagnostic domain arranged in a predefined hierarchical manner in the prompt database 718 and utilize the intent to generate on-demand prompts, also referred to as “dynamic prompts 736” in communication with the prompt database 718. In more embodiments, the diagnostic prompt generation engine 716 may dynamically select relevant prompts and workflows based on the intent and the derived network topologies. The diagnostic prompt generation engine 716 may render the dynamic prompts 736 to the RAG pipeline 720. In additional embodiments, the RAG pipeline 720 may dynamically select relevant diagnostic commands and workflows based on the intent and the derived network topologies.

In further embodiments, the AI-driven NDT system may include a technical resolver configured to employ advanced NLP techniques to rapidly identify and resolve recurring software issues. In still more embodiments, by employing a preprocessed bug database 740 indexed, for example, using Term Frequency-Inverse Document Frequency (TF-IDF), the AI-driven NDT system may be configured to match incoming system logs with historical bug patterns. When system logs (syslogs) are uploaded into the AI-driven NDT system, the contextual insight log extractor 714 may extract relevant system logs and perform a comprehensive similarity search against the indexed bug database 740, thereby allowing the AI-driven NDT system to perform a swift identification of potential bug matches, thereby substantially accelerating the troubleshooting process for bug resolution. By providing instant feedback to the user, for example, in the form of relevant bug identifiers (IDs) and detailed solution recommendations, the AI-driven NDT system may allow the user to quickly address and resolve network issues, minimizing downtime and optimizing operational efficiency. The AI-driven NDT system, may therefore, transform log analysis from a time-consuming manual task into a streamlined, automated process, enhancing overall system reliability and user experience.

Consider an example where the user's input query 722 includes a description of a network issue such as “Why is the network latency high between Server A and Server B?” or “What is causing packet loss on the router?”, and details such as network devices, error messages, and performance metrics that may help in diagnosing the network issue. The RAG pipeline 720 may include a retrieval stage and a generation stage. In the retrieval stage, the RAG pipeline 720 may utilize a retrieval mechanism to gather relevant external network log data that may help identify the network issue. In still further embodiments, the retrieval mechanism may query historical logs, network performance metrics, configuration files, or monitoring tools to retrieve related network log data. The retrieval mechanism may also search through the context database 710 for diagnostic context including, for example, known network issues, troubleshooting guides, or network configuration documents to retrieve relevant network log data. In still additional embodiments, the retrieval mechanism may also search through the ephemeral context 714A received from the contextual insight log extractor 714 and utilize the dynamic prompts 736 received from the diagnostic prompt generation engine 716 to retrieve relevant network log data. The retrieval mechanism may utilize various approaches, for example, a semantic search or embeddings to match the input query 722 with the relevant network log data. In some more embodiments, the retrieval mechanism may extract a reduced set of network log data including, for example, error log data, throughput rates, or time-stamped events, from the retrieved network log data based on a time range when the network issue occurred. The extracted network log data may provide additional context including, for example, error messages associated with the network issue, historical patterns from previous network failures or performance drops, configuration settings that may potentially be incorrect, network topology or configuration data indicating a router misconfiguration or a recent firmware update, to the RAG pipeline 720. The extracted network log data may provide the LLM with the relevant context to make an informed decision.

In the generation stage, once the relevant network log data is extracted, the RAG pipeline 720 may utilize a generative model, for example, the LLM based on transformer architectures such as a Generative Pretrained Transformer (GPT), Bidirectional Encoder Representations from Transformers (BERT), Text-to-Text Transfer Transformer (T5), or the like to analyze the extracted network log data and synthesize an explanation associated with a root cause of the network issue. The generative model may combine the extracted network log data with its own trained knowledge and generate a coherent response. For example, to the input query “Why is the network latency high between Server A and Server B,” the generative model may respond “The network issue is caused by a misconfigured firewall on Router A that is blocking certain ports between the servers, which results in latency.” In another example, to the input query “What is causing packet loss on the router,” the generative model may respond “Packet loss is likely due to an overloaded router, as shown by the performance logs indicating 90% CPU usage during peak traffic.” In yet various embodiments, the generative model may also offer recommendations, for example, explanations, suggestions, or next steps for resolving the network issue, such as specific troubleshooting actions to take. In yet more embodiments, the RAG pipeline 720 may also incorporate follow-up queries to refine the diagnosis further. For example, if the initial root cause suggestion is unclear or not entirely correct, the RAG pipeline 720 may ask for more specific logs or details from the user. The output 738 of the RAG pipeline 720 may be a natural language response that combines insights from the extracted network log data and the AI-based reasoning of the generative model. For example, for the input query “Why is the network latency high between Server A and Server B,” the output 738 of the RAG pipeline 720 may be “Based on the retrieved network log data, the root cause appears to be an incorrect Domain Name System (DNS) configuration on the router, which is delaying name resolution between Server A and Server B.” In a further example, for the input query “What is causing packet loss on the router,” the output 738 of the RAG pipeline 720 may be “the network congestion between the router and the server is contributing to packet loss.”

Although a specific embodiment for a natural language query engine 700 for context-aware, AI-driven network diagnostics and troubleshooting suitable for carrying out the various steps, processes, methods, and operations described herein is discussed with respect to FIG. 7, any of a variety of systems and/or processes may be utilized in accordance with embodiments of the disclosure. For example, in still yet more embodiments, the natural language query engine 700 may further include a log insight ranker configured to rank inferences generated by utilizing the context database 710, the technical resolver, and a graph-based casual analyzer which performs the graph-based casual analysis. The natural language query engine 700 may employ the context database 710, the technical resolver, and the graph-based casual analyzer to dynamically run inference logic to analyze and reason a network issue when a user uploads a new network log, for example, a new show tech log file, by utilizing Representational State Transfer (REST) Application Programming Interfaces (APIs). The log insight ranker may rank the inferences based on the highest probabilistic ranking of network issues that the natural language query engine 700 previously learned based on the embodiments disclosed above. The elements depicted in FIG. 7 may also be interchangeable with other elements of FIGS. 1-6 and FIGS. 8-12 as required to realize a particularly desired embodiment.

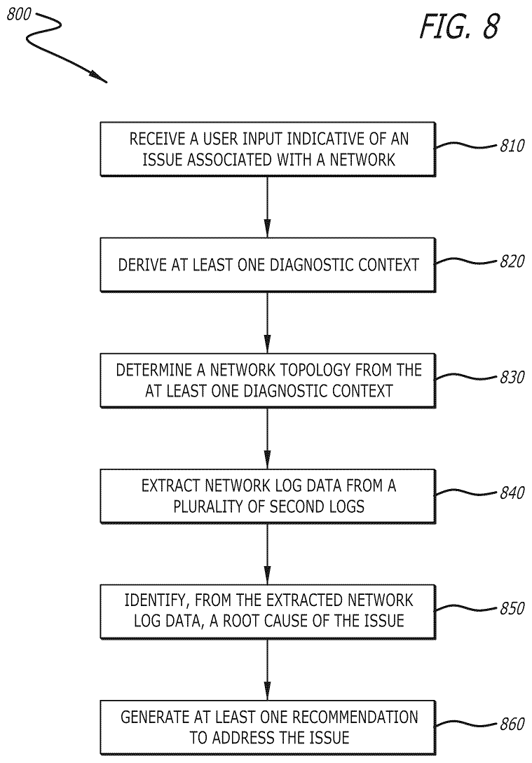

Referring to FIG. 8, a flowchart depicting a process 800 for context-aware, AI-driven network diagnostics and troubleshooting of a previously unclassified issue in accordance with various embodiments of the disclosure is shown. In many embodiments, the process 800 may receive a user input indicative of an issue associated with a network (block 810). In a number of embodiments, the issue may be a new, unknown, or previously unclassified issue. The network may include, for example, a Virtual Extensible Local Area Network (VXLAN), an Ethernet Virtual Private Network (EVPN), a Software-Defined-Wide Area Network (SD-WAN), or the like. In a variety of embodiments, a user may enter the user input via a conversational interface of the AI-driven NDT system. The user input may include, for example, a plurality of first logs associated with a plurality of network devices in the network. The network devices may include, for example, switches, routers, servers, systems, applications, or the like. In various embodiments, the first logs may include show tech logs. The term “show tech” may refer to a command executed on the network devices to gather a wide range of network log data in a single output. In more embodiments, the show tech logs may provide a detailed collection of system status information about various components of each network device. In additional embodiments, the show tech logs may provide a comprehensive snapshot of states and performances of the network devices. The show tech logs may be utilized for diagnosing and troubleshooting the issue indicated in the user input.

In further embodiments, the user input may include at least one of: a description of the issue, an indication regarding one or more subsystems within each of the plurality of network devices, a time range, or one or more topology-specific filter criteria. The description of the issue may include user interaction text describing the issue, for example, “interface error disabled.” The indication regarding one or more subsystems within each of the plurality of network devices may include an indication regarding, for example, one or more file systems, directories, files, or the like with each of the network devices. In still more embodiments, the time range may be configured to target a period when the issue occurred and allow extraction and processing of only relevant log entries constituting network log data associated with the time range. The log entries in a log may refer to records created by a network device to document various system events, for example, status changes, errors, security alerts, configuration changes, performance metrics, or the like. Each log entry may include, for example, a timestamp indicating when an event occurred, an event type indicating the nature of the event such as informational, error, or warning, descriptive information about the event, a severity level, or the like. The term “topology” may refer to an arrangement or a structure of various elements such as network devices, nodes, connections, or the like in the network. The topology associated with the network, also referred to as a “network topology,” may define how different network devices and components are physically or logically connected and how they communicate with each other. The topology-specific filter criteria may include, for example, specific types of log entry masks from relevant network devices. The log entry masks may hide or exclude irrelevant log entries from the first logs.

In still further embodiments, the process 800 may derive at least one diagnostic context (block 820). The process 800 may derive the diagnostic context(s) based on the user input. In still additional embodiments, the user input may set the diagnostic context(s) for network diagnostics by identifying the issue and narrowing the log analysis to a specific set of interfaces, time range, and related log events. The diagnostic context may frame and narrow down potential root causes of the issue by considering various factors and data points. The diagnostic context may include, for example, Command Line Interface (CLI) commands associated with the issue, log extracts or extracted network log data, user-provided descriptions and symptoms of the issue obtained from the user input, diagnostic workflows, findings of a machine learning model, or the like. The CLI commands may include, for example, show interface all, show commands related to the reason for the issue, show logging, show spanning-tree, show tech-support ethpm, or the like, where ethpm may refer to Ethernet port module. In some more embodiments, the diagnostic context may be predefined or derived from the user input. In yet various embodiments, the diagnostic context may be selected via the conversational interface. If the predefined diagnostic context does not fully address the issue or present a new diagnostic context, the process 800 may request the user to manually select additional diagnostic contexts and/or commands related to various components or subsystems of the network devices via the conversational interface to extend the log analysis. In yet more embodiments, the process 800 may dynamically develop the diagnostic context through interactive user input, refining general issue descriptions into specific diagnostic contexts.

In still yet more embodiments, the process 800 may derive the diagnostic context(s) from intent identified in the user input. In many further embodiments, the process 800 may identify the intent based on NLP and conversational AI as follows. The process 800 may preprocess the user input, for example, by tokenization, removing stop words, stemming, or the like. The process 800 may then extract features, for example, keywords, entities or data points such as dates, names, locations, or the like, and context from the preprocessed user input. In many additional embodiments, the process 800 may execute one or more machine learning models, for example, a supervised learning model, to classify the intent. In still yet further embodiments, the process 800 may utilize natural language understanding, contextual understanding, intent mapping, or the like to identify the intent from the user input. In still yet additional embodiments, the process 800 may select a natural language processing parser based on one or more formats associated with the first logs. The process 800 may parse the first logs based on the selected natural language processing parser. In several embodiments, the process 800 may derive the diagnostic context(s) based on the parsed first logs.

In several more embodiments, the process 800 may determine a network topology from the at least one diagnostic context (block 830). The network topology may, for example, be a bus topology, a star topology, a ring topology, a mesh topology, a tree topology, a hybrid topology, or the like. The process 800 may derive the network topology based on the first logs with the identified intent, ensuring retrieval of commands most relevant to the network topology and the type of the issue for the log analysis. In numerous embodiments, the process 800 may dynamically select relevant diagnostic commands and workflows based on the network topology and the identified intent.

In numerous additional embodiments, the process 800 may extract network log data from a plurality of second logs (block 840). The process 800 may extract network log data from the second logs based on at least one of the user input, the network topology, or configurable criteria. In further additional embodiments, the second logs may include a subset of the first logs, obtained based on the configurable criteria. In many embodiments, the configurable criteria may include a time range configured to target a period when the issue occurred. In an example, the second logs may include a subset of the first logs obtained within the time range when the issue occurred. In a further example, the second logs may include logs from multiple routers, switches, and other network components filtered based on the topology-specific filter criteria derived from the user input. The topology-specific filter criteria may ensure that only logs relevant to the issue, for example, the second logs, are included for log analysis, reducing noise and focusing on critical network log data needed for the log analysis. In a number of embodiments, the process 800 may normalize, time-order, and format the filtered logs, that is, the second logs, to facilitate event correlation across the network devices, enabling the AI-driven NDT system to highlight relationships between log entries required for diagnosing the issue. In a variety of embodiments, the configurable criteria may further include an indication regarding one or more subsystems within the network devices. The process 800 may time-order the second logs from various subsystems within each network device and across the network devices. In various embodiments, the process 800 may automatically determine the time range to extract the network log data from the second logs, based on the user input and one or more event correlations in the first logs.

In more embodiments, the process 800 may store the extracted network log data in a vector database, for example, associated with RAG. In additional embodiments, the process 800 may store the user input, the diagnostic context(s), and the extracted network log data in a context database. In further embodiments, the context database is configured as a reusable knowledge base to provide automated diagnostics for one or more subsequent issues. In still more embodiments, the process 800 may render a conversational interface for receiving one or more queries associated with the second logs from the user. The process 800 may translate the received queries into at least one command corresponding to the network. In still further embodiments, the process 800 may extract the network log data from the second logs further based on the command(s).

In still additional embodiments, the process 800 may identify, from the extracted network log data, a root cause of the issue (block 850). The root cause of the issue may refer to a primary, underlying factor or source that directly causes a problem or failure to occur. Addressing the root cause may resolve the issue at its core, preventing the issue from recurring. The root cause may not be just a symptom of the issue such as a slow network or a malfunctioning device, but an actual origin, such as a configuration error, a hardware failure, a software bug, a human error, a miscommunication or a lack of training, a design flaw, or the like. In an example, if a network is experiencing frequent outages, while the symptom may be network downtime, the root cause may be a faulty router that consistently fails due to overheating. By identifying and fixing the root cause, rather than just addressing the symptom, temporary fixes may be avoided, ensuring long-term solutions. In some more embodiments, the process 800 may execute a machine learning model to identify the root cause of the issue. The machine learning model is, for example, an LLM. In yet various embodiments, the process 800 may generate one or more prompts for the machine learning model based on at least one of: the user input, the extracted network log data, the network topology, one or more pre-processed bug signatures associated with the issue, or the vector database associated with the extracted network log data. The process 800 may then input the prompt(s) to the machine learning model. The process 800 may identify the root cause of the issue based on an output of the machine learning model for the prompt(s).

In yet more embodiments, the process 800 may generate at least one recommendation to address the issue (block 860). The process 800 may generate at least one recommendation based on the root cause to address the issue. In still yet more embodiments, the recommendation(s) may correspond to a bug match for the issue. In many further embodiments, the process 800 may generate at least one actionable recommendation based on the root cause to address the issue. The actionable recommendation may refer to a specific, clear, and practical suggestion that can be directly implemented to address the issue. The actionable recommendation may provide precise steps or interventions that the user can take to resolve the issue. In many additional embodiments, by utilizing reduced logs with focused RAG and the user input, the process 800 can provide actionable recommendations such as suggesting potential bug matches. In still yet further embodiments, the recommendation(s) may correspond to at least one summary associated with the issue. By generating predefined and dynamic prompts and rendering LLM-powered responses, the user can receive instant, actionable insights into the issue without sifting through extensive logs manually. The use of context-aware prompts may allow for proactive diagnostics, where emerging issues can be flagged based on historical log patterns.

In various embodiments, the process 800 may provide a zoom-in and zoom-out functionality associated with the time range via a set of APIs. The process 800 may render the identified root cause in an automatically determined time range, for example, 20-second window, a 30-second window, or a 1-minute window. The zoom-in and zoom-out functionality may allow the user to zoom out and review transactions that occurred, microservices involved, or the like, for example, at more than 1 minute, or zoom in and narrow down to a given second to review transactions that occurred, microservices involved, or the like in that second. The zoom-in and zoom-out functionality may allow the user to further drill down and enter more queries to analyze the root cause.

Consider an example of diagnosing and troubleshooting a previously unclassified issue, for example, an interface error disabled issue associated with network switches. A user, for example, a network administrator, may upload show tech logs from affected network switches and specify an issue type “interface error disabled,” as a user input to the AI-driven NDT system. This user input received via the conversational interface may set the context for the AI-driven NDT system by identifying the issue and narrowing the log analysis to a specific set of interfaces, a time range, and related log events. In still yet additional embodiments, the AI-driven NDT system may derive a relevant diagnostic context for interface error-disabled issues. The diagnostic context may include, for example, CLI commands such as show interface all, show commands related to an error disable reason, show logging, show spanning-tree, show tech-support ethpm, or the like. If the predefined diagnostic context does not fully address the issue or present a new diagnostic context, the user may manually select additional contexts and/or commands related to various components and/or subsystems via the conversational interface to extend the log analysis. The AI-driven NDT system may identify a relevant time range and specific commands for the log analysis. The AI-driven NDT system may determine a network topology based on the show tech logs along with the user's intent ensuring the commands most relevant to the network topology and the type of the issue are retrieved for the log analysis.

In several embodiments, the AI-driven NDT system may parse the show tech logs across all components, for example, a driver, hardware, Universal Serial Bus (USB)/Hardware Abstraction Layer (HAL), a control plane, a protocol, software modules, or the like. The AI-driven NDT system may extract network log data from relevant second logs and sorts the second logs chronologically, focusing on a specific time range defined by cumulative windows of failures across clients or network devices, thereby ensuring the log analysis is targeted to a period when the issue occurred, avoiding noise from unrelated events. The AI-driven NDT system may store the extracted log data in a vector database for optimal querying and structured analysis. In several more embodiments, the AI-driven NDT system may classify the issue, for example, as “interface error-disabled” and retrieve a corresponding prompt template such as “Why is the interface error-disabled?”, if the prompt template exists. If the prompt template exists, the AI-driven NDT system may select an appropriate RAG filter pipeline present in the AI-driven NDT system and provide a recommendation to the user. In numerous embodiments, the AI-driven NDT system may identify a possible open bug or may generate a summarized analysis that highlights the issue for further debugging. If the prompt template does not exist for the issue, the AI-driven NDT system may generate a prompt by combining, for example, user-provided context such as interface-specific logs, extracted logs from the specified time range including spanning-tree error messages, driver faults, control plane, or the like, preprocessed bug signatures relevant to interface error-disabled issues, topology-specific insights, and a vector database for the current log extracts. The AI-driven NDT system may filter the prompts to ensure that the prompts are precise and context-aware.

In numerous additional embodiments, the AI-driven NDT system may render the prompts to a trained machine learning model with a RAG pipeline, for example, an LLM, for log analysis. The AI-driven NDT system may identify patterns that suggest root causes, for example, misconfiguration such as BPDU guard violations, hardware-related faults such as a faulty transceiver or port, or the like. The LLM may provide recommended corrective actions, for example, disabling the BPDU guard, replacing the hardware component such as the transceiver, or the like. The AI-driven NDT system renders the diagnostic context to the user via the conversational interface. After reviewing the log analysis, the user may store the diagnostic context including CLI commands, relevant log extracts, the network topology, related prompts, and a description of the issue in plain English, in the context database. The enriched diagnostic context may be stored in the context database and made available for future diagnostics of similar issues and for model training purposes.

Although a specific embodiment for a process 800 for context-aware, AI-driven network diagnostics and troubleshooting of a previously unclassified issue suitable for carrying out the various steps, processes, methods, and operations described herein is discussed with respect to FIG. 8, any of a variety of systems and/or processes may be utilized in accordance with embodiments of the disclosure. For example, the process 800 may utilize other techniques such as named entity recognition, text classification models, time series analysis models, support vector machines, RNNs, fault tree analysis, or the like for identifying the root cause of the issue from the extracted network data. The elements depicted in FIG. 8 may also be interchangeable with other elements of FIGS. 1-7 and FIGS. 9-12 as required to realize a particularly desired embodiment.

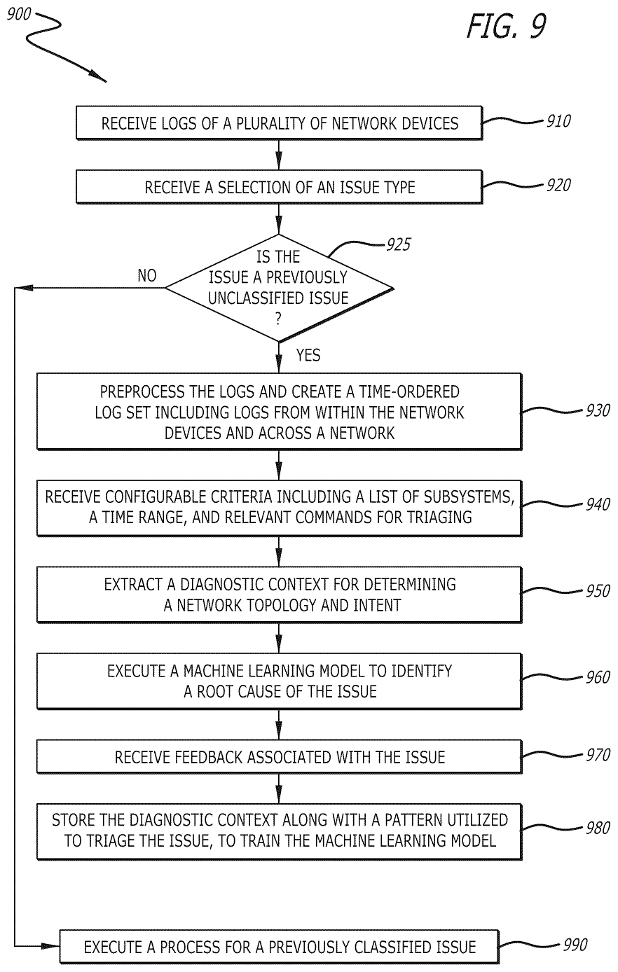

Referring to FIG. 9, a flowchart depicting a process 900 for diagnosing a previously unclassified issue associated with a network in accordance with various embodiments of the disclosure is shown. In many embodiments, the process 900 may receive logs of a plurality of network devices (block 910). The process 900 may receive the logs from a user via a conversational interface of the AI-driven NDT system. In a number of embodiments, the logs may include show tech logs. The network devices may include, for example, switches, routers, servers, systems, applications, or the like.

In a variety of embodiments, the process 900 may receive a selection of an issue type (block 920). The issue type may include, for example, a new issue, a known issue, or the like. The user may select the issue type, for example, via a dropdown menu, on the conversational interface. In various embodiments, the user may provide a description of the issue along with the issue type. The process 900 may receive the user-provided description via the conversational interface.

In more embodiments, the process 900 may determine whether the issue is a previously unclassified issue (block 925). The previously unclassified issue may refer to a problem or a disruption in the network that has not been classified or defined in existing troubleshooting frameworks or known issue databases. The previously unclassified issue may be a new type of malfunction or a complex combination of factors that have not been encountered before or lack a clear solution in the current knowledge base. Examples of previously unclassified issues may include emerging security vulnerabilities, uncommon configuration conflicts, unexpected performance degradation issues, intermittent connectivity problems, new protocol or service failures, or the like. The emerging security vulnerabilities may include, for example, new exploits or attack vectors that have not been discovered or identified by security researchers and, therefore, may not be classified in threat databases. The uncommon configuration conflicts may include, for example, unusual interactions between hardware, software, or network configurations that may not fit into established patterns, making them difficult to diagnose. The unexpected performance degradation issues may include, for example, network slowdowns or bottlenecks due to new technologies or usage patterns such as an unforeseen impact of AI or Internet-of-Things (IoT) traffic on existing network infrastructure. The intermittent connectivity problems may include, for example, problems that appear sporadically or under specific, yet undefined conditions, such as new interference patterns in wireless networks that have not been seen before. The new protocol or service failures may include, for example, previously undetected failures or flaws in new or updated protocols such as new versions of a HyperText Transfer Protocol (HTTP) or DNS, or proprietary protocols causing issues across multiple network devices or systems.

In additional embodiments, in response to determining that the issue is a previously unclassified issue, the process 900 may preprocess the logs and create a time-ordered log set including logs from within the network devices and across a network (block 930). The logs from within the network devices and across the network may include logs from routers, firewalls, switches, servers, intrusion detection systems, load balancers, or the like. These logs may be in different formats, for example, a syslog format, a JSON format, or other proprietary formats. In further embodiments, the process 900 may normalize these logs into a standardized format to allow convenient log analysis, event correlation, and detection of issues from within the network devices and across the network. The process 900 may parse these logs into structured data fields. Each log may include multiple pieces of information, for example, timestamps, IP addresses, status codes, error messages, device names, or the like. The process 900 may select a parser, for example, an NLP parser, based on one or more formats associated with the logs to parse the logs. The process 900 may further time-order the logs from various subsystems within the network devices and across the network devices. In still more embodiments, the process 900 may time-order each log by arranging log entries in a chronological order based on their timestamps.

In still further embodiments, the process 900 may receive configurable criteria including a list of subsystems, a time range, and relevant commands for triaging (block 940). The user may select a list of subsystems, for example, drivers, hardware, a control plane, a protocol, software modules, or the like, within the network devices via the conversational interface. In still additional embodiments, the user may select a time range to target a period when the issue occurred, via the conversational interface. In some more embodiments, the user may select CLI commands such as show interface all, show logging, show spanning-tree, show tech-support ethpm, or the like for triaging, via the conversational interface. The process 900 may receive the selected list of subsystems, the selected time range, and the selected commands for triaging via the conversational interface.

In yet various embodiments, the process 900 may extract a diagnostic context for determining a network topology and intent (block 950). In yet more embodiments, the process 900 may dynamically build context-aware diagnostics through interactive user input, while refining the general description of the issue into a specific diagnostic context. In still yet more embodiments, the process 900 may utilize the extracted diagnostic context to derive or map with a network topology and an intent associated with the issue to extract and process only relevant network log data, ensuring an optimal and scalable log analysis. The diagnostic context may include, for example, the selected CLI commands, log extracts, user-provided descriptions and symptoms of the issue, diagnostic workflows, findings, or the like. The process 900 may derive the network topology based on the logs with the identified intent, ensuring retrieval of commands most relevant to the network topology and the type of the issue for the log analysis. While the user may input only the logs into the AI-driven NDT system, the AI-driven NDT system may automatically determine the network topology and the intent from various sources including, for example, other logs within the network devices and across the network and the diagnostic context stored in the context database. For example, when the user inputs a description of an issue such as “Border Gateway Protocol (BGP) sessions are down” and provides a show tech log file of relevant network devices to the AI-driven NDT system, the AI-driven NDT system may determine the intent from the description of the issue and may determine the network topology by analyzing the show tech log file and identifying microservices that are enabled, their configurations, triaging components, or the like. In this example, the AI-driven NDT system may determine the network topology as VXLAN topology, Virtual Port Channel (VPC) topology, an L2 switch, an L3 switch, or the like. In many further embodiments, the process 900 may dynamically select relevant diagnostic commands and workflows based on the network topology and the identified intent.

In many additional embodiments, the process 900 may execute a machine learning model to identify a root cause of the issue (block 960). The machine learning model is, for example, an LLM. In still yet further embodiments, the process 900 may generate one or more prompts for the machine learning model based on at least one of: the user input, the extracted network log data, the network topology, one or more pre-processed bug signatures associated with the issue, or the vector database associated with the extracted network log data. The process 900 may then input the prompt(s) to the machine learning model. The process 900 may identify the root cause of the issue based on an output of the machine learning model for the prompt(s).

In still yet additional embodiments, the process 900 may receive feedback associated with the issue (block 970). The process 900 may receive feedback on the issue and the identified root cause of the issue from the user via the conversational interface. With the identification of the root cause, the process 900 may provide insights based on previous learnings to the user via the conversational interface. The user may review the identified root cause of the issue and the insights and provide an acknowledgement and/or feedback associated with the issue. The process 900 may retrain the machine learning model to generate updated findings based on the received feedback. In several embodiments, the process 900 may iterate the process of retraining the machine learning model and generating updated findings based on the received feedback until the user acknowledges the identified root cause of the issue.

In several more embodiments, the process 900 may store the diagnostic context along with a pattern utilized to triage the issue, to train the machine learning model (block 980). The machine learning model may utilize a particular pattern to triage the issue and identify the root cause of the issue acknowledged by the user. In numerous embodiments, the process 900 may store the diagnostic context with a label in a context database. In numerous additional embodiments, the process 900 may store the labeled diagnostic context and the pattern utilized to triage the issue in the context database. The storage of the diagnostic context and the pattern may create a reusable knowledge base with reusable diagnostic contexts utilized for training the machine learning model. This reusable knowledge base may help improve future automated diagnostics for one or more subsequent issues, collaborative learning, and knowledge sharing across teams. In further additional embodiments, the process 900 may store the description of the issue, the identified intent, and signature as English sentences as part of context metadata in the context database.

However, in many embodiments, in response to determining that the issue is not a previously unclassified issue, the process 900 may execute a process for a previously classified issue (block 990). The previously classified issue may refer to a problem or a fault that has been identified, classified, and recorded by users, for example, network administrators or automated systems, based on historical data or recurring patterns. Previously classified issues may include known problems with established causes and solutions, that may be recorded in a database or a knowledge base for future reference. The previously classified issue may be a recurring issue such as a network congestion, interface errors, or DNS resolution failures that have been seen and resolved multiple times. The previously classified issue may be assigned a specific classification, for example, “routing loop,” “bandwidth saturation,” “DNS misconfiguration,” or “interface flapping,” which may assist the users in quickly understanding the nature of the issue and how to address the issue. Since the issue is previously classified, there may be predefined solutions, mitigation steps, or troubleshooting procedures that can be followed to resolve the issue.

Although a specific embodiment for a process 900 for diagnosing a previously unclassified issue associated with a network suitable for carrying out the various steps, processes, methods, and operations described herein is discussed with respect to FIG. 9, any of a variety of systems and/or processes may be utilized in accordance with embodiments of the disclosure. For example, in a number of embodiments, the process 900 may execute more than one machine learning model trained to identify outliers or unusual patterns indicative of the previously unclassified issue based on network metrics for diagnosing the previously unclassified issue associated with the network. The elements depicted in FIG. 9 may also be interchangeable with other elements of FIGS. 1-8 and FIGS. 10-12 as required to realize a particularly desired embodiment.

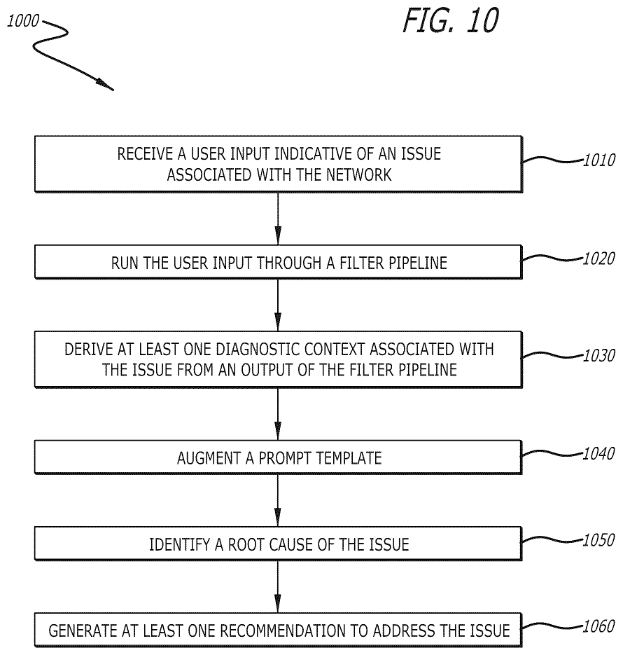

Referring to FIG. 10, a flowchart depicting a process 1000 for context-aware, AI-driven network diagnostics and troubleshooting of a previously classified issue in accordance with various embodiments of the disclosure is shown. In many embodiments, the process 1000 may receive a user input indicative of an issue associated with the network (block 1010). In a number of embodiments, the issue may be known or previously classified issue. The previously classified issue may include a known problem with established causes and solutions, that may be recorded in a database or a knowledge base for future reference. The previously classified issue may be a recurring issue such as a network congestion, interface errors, or DNS resolution failures that have been seen and resolved multiple times. The network may include, for example, a Virtual Extensible Local Area Network (VXLAN), an Ethernet Virtual Private Network (EVPN), a Software-Defined-Wide Area Network (SD-WAN), or the like. In a variety of embodiments, a user may enter the user input via a conversational interface of the AI-driven NDT system. The user input may include, for example, a plurality of logs associated with a plurality of network devices in the network. The network devices may include, for example, switches, routers, servers, systems, applications, or the like. In various embodiments, the logs may include show tech logs. In more embodiments, the show tech logs may provide a detailed collection of system status information about various components of each network device. In additional embodiments, the show tech logs may provide a comprehensive snapshot of states and performances of the network devices. The show tech logs may be utilized for diagnosing and troubleshooting the issue indicated in the user input.

In further embodiments, the process 1000 may run the user input through a filter pipeline (block 1020). In still more embodiments, the filter pipeline may be a RAG-based pipeline. The RAG-based pipeline may filter the logs to relevant sections, for example, log extracts, prompts, or the like, before passing the logs to a machine learning model such as an LLM, optimizing prompt relevance and response accuracy for resolution of the issue. The RAG-based pipeline may facilitate targeted log summarization. In still further embodiments, the process 1000 may execute the filter pipeline to infer the issue through AI-based inferencing. In still additional embodiments, the process 1000 may retrieve a predefined prompt template for the class of the issue from a prompt database. The prompt template may refer to a predefined structure that specifies what kind of information should be gathered or queried. The predefined prompt template may, for example, be a predefined RAG template associated with a vector database. In some more embodiments, the prompt database may be a repository of various prompt templates that are represented as signatures of individual issues for a given operating system stored and constructed as a graph. The process 1000 may extract the user's intent from the user input. The process 1000 may then map the intent to a corresponding prompt template associated with a diagnostic domain which may be arranged in a predefined hierarchical manner in the prompt database for evaluating a diagnostic context.

In yet various embodiments, the process 1000 may derive at least one diagnostic context associated with the issue from an output of the filter pipeline (block 1030). The diagnostic context(s) may include a network topology, network log data, a time range, or one or more topology-specific filter criteria associated with the issue. The network topology may define how different network devices and components may be physically or logically connected and how they communicate with each other. The topology-specific filter criteria may include, for example, specific types of log entry masks from relevant network devices. The log entry masks may hide or exclude irrelevant log entries from the logs received from the user input. The process 1000 may utilize the diagnostic context(s) for narrowing the log analysis to a specific set of interfaces, time range, and related log events. The diagnostic context may frame and narrow down potential root causes of the issue by considering various factors and data points. The diagnostic context may include, for example, CLI commands associated with the issue, time range, log extracts or extracted network log data, user-provided descriptions and symptoms of the issue obtained from the user input, diagnostic workflows, findings of the machine learning model such as the LLM utilized in the filter pipeline, or the like. In yet more embodiments, the process 1000 may dynamically develop the diagnostic context through interactive user input, refining general issue descriptions into specific diagnostic contexts.

In still yet more embodiments, the process 1000 may augment a prompt template (block 1040). The process 1000 may augment the prompt template based on the diagnostic context(s). The process 1000 may augment the prompt template to provide necessary details and diagnostic context to identify the root cause of the issue. The prompt template may include placeholders that may be filled dynamically based on the diagnostic context. For example, for a latency issue, the prompt template may focus on gathering latency measurements and error counters. In a further example, for a routing issue, the prompt template may focus on routing table discrepancies and path metrics. If the issue happens intermittently or during a specific time period, the process 1000 may include a time range in the prompt template to narrow down the issue. An example of an augmented prompt template may include “The issue in question is related to a BPDU Guard violation on port [PORT_NAME] of switch [SWITCH_NAME]. The affected device is [SWITCH_NAME] with IP address [SWITCH_IP]. The port [PORT_NAME] was placed in the “err-disabled” state after receiving a BPDU, violating the BPDU Guard policy. The issue was observed between [TIME_START] and [TIME_END]. Relevant symptoms include port [PORT_NAME] being disabled during the time range specified. Please check the following:—**Port Status**: Use the command ‘show interface [PORT_NAME]’ to check if the port is in ‘err-disabled’ state during the specified time range.—**BPDU Guard Settings**: Verify that BPDU Guard is enabled on the port by reviewing the command ‘show running-config interface [PORT_NAME]’ to ensure correct configuration.—**STP Settings**: Check if the port should be an edge port (access port) during the time range by running the command ‘show spanning-tree interface [PORT_NAME]’. Confirm that the port was not participating in STP.—**Logs**: Examine the logs from [TIME_START] to [TIME_END] for any entries related to BPDU Guard being triggered or the port entering the ‘err-disabled’ state. You can use the command ‘show logging’ and filter logs for this time range (e.g., ‘show logging|include [TIME_START]-[TIME_END]’).—**Network Topology**: Ensure that no unintended switches or devices were connected to the affected port during the specified time range, leading to BPDU transmission. Review the physical topology to identify any misconfigurations or devices that may have incorrectly sent BPDU frames.” In many further embodiments, the process 1000 may automatically determine the time range to extract the network log data from the logs based on the user input and one or more event correlations in the logs. In many additional embodiments, the process 1000 may automatically determine the time range for log analysis based on the user intent and cumulative failure events across the network devices and subsystems to minimize noise and ensure that only the most relevant logs are analyzed, saving time and improving focus.

In still yet further embodiments, the process 1000 may identify a root cause of the issue (block 1050). The process 1000 may identify the root cause of the issue based on the augmented prompt template. In still yet additional embodiments, the process 1000 may input the augmented prompt template to a machine learning model. The machine learning model may, for example, an LLM. The process 1000 may identify the root cause of the issue based on an output of the machine learning model. The process 1000 may identify patterns that suggest the root cause, for example, misconfiguration such as BPDU guard violations, hardware-related faults such as a faulty transceiver or port, or the like.

In several embodiments, the process 1000 may generate at least one recommendation to address the issue (block 1060). The process 1000 may generate the recommendation(s) based on the root cause to address the issue. The machine learning model, for example, the LLM, may provide recommended corrective actions, for example, disabling the BPDU guard or replacing the hardware component such as the transceiver, or the like. The process 1000 may generate at least one recommendation based on the root cause to address the issue. In several more embodiments, the recommendation(s) may correspond to a bug match for the issue. In numerous embodiments, the process 1000 may run the filter pipeline with existing contexts and match against a preprocessed bug database of the AI-driven NDT system containing bug ID signatures. The preprocessed bug database with TF-IDF indexing may allow the AI-driven NDT system to match current network log data with similar historical bugs, providing relevant bug IDs. In numerous additional embodiments, by utilizing reduced logs with focused RAG and the user input, the process 1000 can provide actionable recommendations such as suggesting potential bug matches. In further additional embodiments, the recommendation(s) may correspond to at least one summary associated with the issue. In many embodiments, the process 1000 may prioritize bugs in the order of relevance and render the summary to the user. By augmenting the prompt templates and rendering LLM-powered responses, the user can receive instant, actionable insights into the issue without sifting through extensive logs manually. The use of context-aware prompts may allow for proactive diagnostics, where emerging issues can be flagged based on historical log patterns.

Consider an example of diagnosing and troubleshooting a previously classified issue such as a connectivity issue in an EVPN-VXLAN network. A user, for example, a network administrator, may enter a user input via the conversational interface of the AI-driven NDT system, reporting the connectivity issue via a user interaction text describing that a host IP 194.0.0.1 is not reachable for some user devices associated with source IP addresses in the EVPN-VXLAN network, while other user devices can access the host IP. The AI-driven NDT system may receive the user input and process the user interaction text along with logs, for example, show-tech logs, from relevant network devices through the NLP-based ILPM module of the AI-driven NDT system. In a number of embodiments, the ILPM module may identify, from the user input, intent such as: Host 194.0.0.1 as the destination; VXLAN Tunnel End Points (VTEPs), namely, VTEPs 194-a and VTEPs 194-b as relevant network endpoints towards destination host; VXLAN VTEPs where source host (user devices) is attached; the underlay routing towards VTEPs194-a and VTEPs194-b; EVPN-VXLAN reachability information on source VTEPs towards host 194.0.0.1; the need for Address Resolution Protocol (ARP), adjacency, Media Access Control (MAC) information on VTEP endpoints; and the usage of consistency checkers and other related commands as troubleshooting tools.

The AI-driven NDT system may then match the identified intent to predefined RAG templates and an associated vector database for evaluation of a network topology and log analysis, particularly targeting EVPN-VXLAN connectivity issues. For example, the AI-driven NDT system may identify known “good” clients, that is, user devices with successful connections, and “failing” clients, based on the network log data from the logs and the network topology. In a variety of embodiments, the AI-driven NDT system may incorporate the time range provided by the user to isolate logs during the period when the connectivity issue was observed. The AI-driven NDT system may filter the logs based on the time range and optionally subsystems involved based on the user input. The AI-driven NDT system may filter the logs from the relevant network devices, for example, vTEP194-a and vTEP194-b, for log entries within the specified time range, focusing on the diagnostic context of the connectivity issue. The AI-driven NDT system may then perform topology-specific context generation. For example, based on the intent, the diagnostic context, and the time range, the AI-driven NDT system may select specific prompt templates for EVPN-VXLAN diagnostics. The prompt templates may include, for example, commands to validate routing, adjacency, and MAC address programming. The commands may include, for example, show ip arp, show ip adjacency, show mac address-table, show ip route, show consistency, etc.

In various embodiments, the AI-driven NDT system may then query logs from the network devices associated with vTEP194-a and VTEP194-b and extracts relevant log entries as network log data. The AI-driven NDT system may perform an automated log analysis and identify a discrepancy, for example, “adjacency is programmed correctly on VTEP194-a but not on VTEP194-b”. In more embodiments, the AI-driven NDT system may then search a bug database for known issues matching the network topology and the extracted log entries or patterns with specified time-range filters. The AI-driven NDT system may identify a possible open bug or generate a summarized analysis that highlights the connectivity issue for further debugging. The user may then review the findings and can accept or refine the diagnosis, adding any additional insights to train the AI-driven NDT system further. The AI-driven NDT system may store the updated diagnostic context including, for example, commands, the logs, and descriptions of the issue in the context database for future use.

Although a specific embodiment for a process 1000 for context-aware, AI-driven network diagnostics and troubleshooting of a previously classified issue suitable for carrying out the various steps, processes, methods, and operations described herein is discussed with respect to FIG. 10, any of a variety of systems and/or processes may be utilized in accordance with embodiments of the disclosure. For example, in additional embodiments, the process 1000 may augment the prompt template to focus on performance-related issues such as latency, packet loss, bandwidth utilization, or the like. The elements depicted in FIG. 10 may also be interchangeable with other elements of FIGS. 1-9 and FIGS. 11-12 as required to realize a particularly desired embodiment.

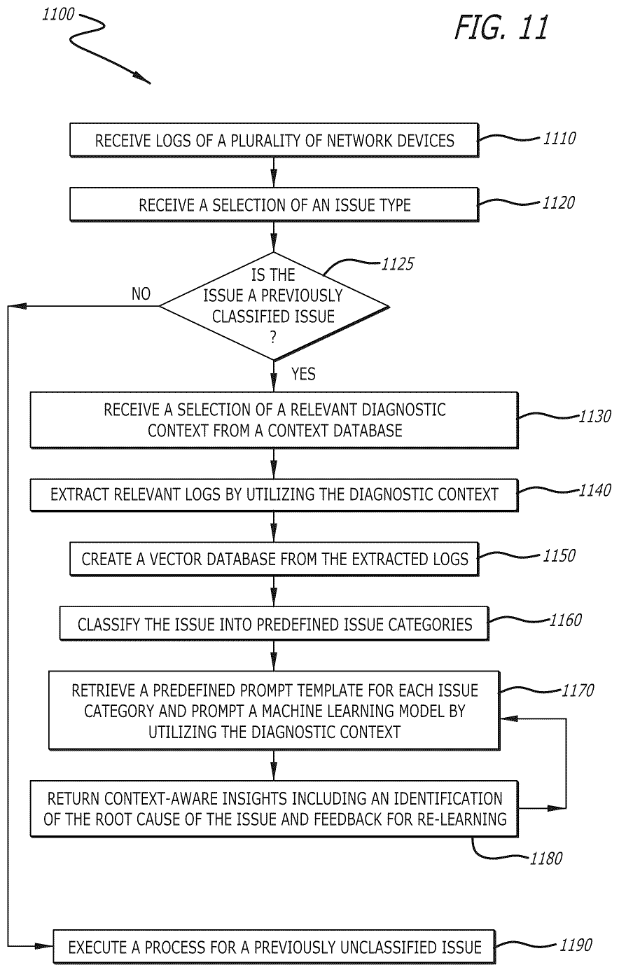

Referring to FIG. 11, a flowchart depicting a process 1100 for diagnosing a previously classified issue associated with a network in accordance with various embodiments of the disclosure is shown. In many embodiments, the process 1100 may receive logs of a plurality of network devices (block 1110). The process 1100 may receive the logs from a user via a conversational interface of the AI-driven NDT system. In a number of embodiments, the logs may include show tech logs. The network devices may include, for example, switches, routers, servers, systems, applications, or the like.

In a variety of embodiments, the process 1100 may receive a selection of an issue type (block 1120). The issue type may include, for example, a new issue, a known issue, or the like. The user may select the issue type, for example, via a dropdown menu, on the conversational interface. In various embodiments, the user may provide a description of the issue along with the issue type. The process 1100 may receive the user-provided description via the conversational interface.

In more embodiments, the process 1100 may determine whether the issue is a previously classified issue (block 1125). The previously classified issue may refer to a problem or a fault that has been identified, classified, and recorded by users, for example, network administrators or automated systems, based on historical data or recurring patterns. Previously classified issues may include known problems with established causes and solutions, that may be recorded in a database or a knowledge base for future reference. The previously classified issue may be a recurring issue such as a network congestion, interface errors, or DNS resolution failures that have been seen and resolved multiple times. The previously classified issue may be assigned a specific classification, for example, “routing loop,” “bandwidth saturation,” “DNS misconfiguration,” or “interface flapping,” which may assist the users in quickly understanding the nature of the issue and how to address the issue. Since the issue is previously classified, there may be predefined solutions, mitigation steps, or troubleshooting procedures that can be followed to resolve the issue.

In additional embodiments, in response to determining that the issue is a previously classified issue, the process 1100 may receive a selection of a relevant diagnostic context from a context database (block 1130). The context database may refer to a knowledge base configured to analyze user interactions with a log storage module of the AI-driven NDT system to derive insights into the user's intent and context. In further embodiments, the context database may organize the user interactions into a set of executable queries that can be applied to any log database. By segmenting user sessions into multiple contexts, the context database may identify various potential interpretations and unlock valuable insights. In still more embodiments, the context database may also track an evolving intent of the user throughout a user session, enabling more accurate and relevant responses. In still further embodiments, the context database may capture a user-specific context, allowing for personalized interactions tailored to individual user preferences and behaviors. The process 1100 may implement a hierarchical organization of user context and intent information in the context database for optimal retrieval and analysis, leading to improved user experience and productivity. The context database may store the intent, insights, and the context as diagnostic context. The diagnostic context may include, for example, a network topology, network log data, a time range, or one or more topology-specific filter criteria associated with the issue.

In still additional embodiments, the process 1100 may extract relevant logs by utilizing the diagnostic context (block 1140). For example, the process 1100 may derive the network topology and the intent from the diagnostic context and extract logs of the network devices in the derived network topology based on the intent. In a further example, the process 1100 may derive the topology-specific filter criteria from the diagnostic context and extract only the logs relevant to the topology-specific filter criteria, thereby reducing noise and in turn, the data size, and focusing only on information needed for the log analysis. In some more embodiments, the topology-specific filter criteria may include, for example, specific types of log entry masks from relevant network devices. The log entry masks may hide or exclude irrelevant log entries from the logs. In yet various embodiments, the process 1100 may derive the time range from the diagnostic context and extracted the logs based on the time range.

In yet more embodiments, the process 1100 may create a vector database from the extracted logs (block 1150). The process 1100 may store the extracted logs and the associated network log data in the vector database. Search algorithms may utilize the vector database to retrieve relevant network log data. The vector database may store the extracted logs as embeddings in a high-dimensional space, allowing for fast and accurate retrieval of the network log data based on semantic similarity.

In still yet more embodiments, the process 1100 may classify the issue into predefined issue categories (block 1160). The categories may include, for example, connectivity issues, performance issues, security issues, configuration issues, or the like. In many further embodiments, the process 1100 may classify the issue into predefined issue categories by utilizing the vector database. For example, the process 1100 may classify the issue into predefined issue categories based on the extracted logs and the associated network log data stored in the vector database as vectors.

In many additional embodiments, the process 1100 may retrieve a predefined prompt template for each issue category and prompt a machine learning model by utilizing the diagnostic context (block 1170). The predefined prompt template may, for example, be a predefined RAG template. The process 1100 may retrieve the predefined prompt template for each issue category from a prompt database of the AI-driven NDT system. The prompt database may include prompt templates that may be represented as signatures of individual issues. The process 1100 may map the diagnostic context including, for example, the intent, network topology, time range, or the like to a corresponding prompt template stored in the prompt database and utilize the diagnostic context to generate on-demand prompts, also referred to as “dynamic prompts”. The process 1100 may utilize these dynamic prompts to prompt the machine learning model. The process 1100 may feed the dynamic prompts into the machine learning model or a RAG pipeline. The machine learning model may, for example, be a custom-trained LLM. By utilizing reduced logs with focused RAG and inputs, the LLM can identify known network issues, evaluate relationships between relevant entries in the extracted logs, and provide actionable recommendations. The precision obtained from reducing the logs may avoid extraneous information that can obscure the diagnosis, allowing the AI-driven NDT system to provide clear insights into actual root causes or corrective actions for the network issue reported by a user.

In still yet further embodiments, the process 1100 may return context-aware insights including an identification of the root cause of the issue and feedback for re-learning (block 1180). By executing the machine learning model, for example, the LLM, the process 1100 may identify the root cause and generate context-aware insights. The process 1100 may identify the root cause of the issue based on an output of the machine learning model for the prompt(s). The process 1100 may retrain the machine learning model to generate updated findings based on the feedback received from the user. In still yet additional embodiments, the process 1100 may obtain feedback from the user to verify conclusions drawn by the machine learning model by checking for logical consistency in the root cause analysis, verifying the relevance of the network log data utilized in the log analysis, cross-referencing suggested remediation steps with known best practices or historical solutions for similar events, or the like. With the feedback, the process 1100 may provide more contextual understanding or higher-level insights across the network. The process 1100 may then reiterate the step of retrieving a predefined prompt template for each issue category and prompt the machine learning model by utilizing the diagnostic context (block 1170).

However, in several embodiments, in response to determining that the issue is not a previously classified issue, the process 1100 may execute a process for a previously unclassified issue (block 1190). The previously unclassified issue may refer to a problem or a disruption in the network that has not been classified or defined in existing troubleshooting frameworks or known issue databases. The previously unclassified issue may be a new type of malfunction or a complex combination of factors that have not been encountered before or lack a clear solution in the current knowledge base. Examples of previously unclassified issues may include emerging security vulnerabilities, uncommon configuration conflicts, unexpected performance degradation issues, intermittent connectivity problems, new protocol or service failures, or the like.

Although a specific embodiment for a process 1100 for diagnosing a previously classified issue associated with a network suitable for carrying out the various steps, processes, methods, and operations described herein is discussed with respect to FIG. 11 any of a variety of systems and/or processes may be utilized in accordance with embodiments of the disclosure. For example, in several more embodiments, the process 1100 may implement cross-domain network diagnostics and troubleshooting with multi-technology integration in the AI-driven NDT system, where logs from different technological domains such as conventional networking, Software-Defined Networking (SDN), cloud, security systems, applications, or the like, are integrated to provide a comprehensive view and more diagnostic context for AI-driven network diagnostics and troubleshooting. The elements depicted in FIG. 11 may also be interchangeable with other elements of FIGS. 1-10 and FIG. 12 as required to realize a particularly desired embodiment.

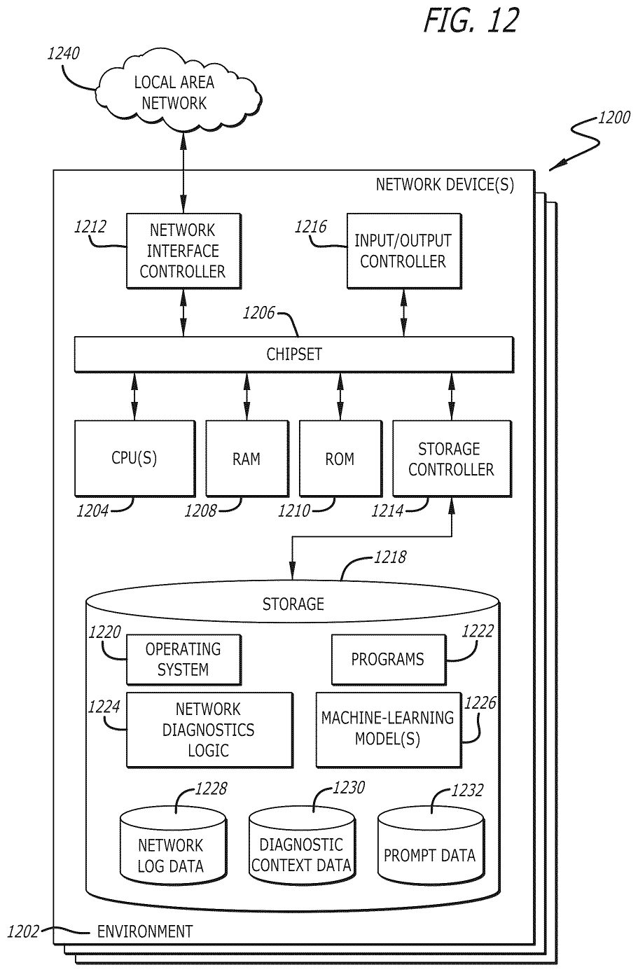

Referring to FIG. 12, a conceptual block diagram of a device 1200 suitable for configuration with the network diagnostics logic 1224 for implementing the functionality and various embodiments of the disclosure is shown. The embodiment of the device 1200 in the conceptual block diagram depicted in FIG. 12 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1200 may, in some examples, correspond to a physical device or to a virtual resource described herein. The device 1200 can be a network device, for example, an access point, a router, a switch, any type of edge-based network device, a server, a system, or the like in accordance with various embodiments of the disclosure.

In many embodiments, the device 1200 may include an environment 1202 such as a baseboard or a “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In a number of embodiments, one or more processors 1204, such as, but not limited to, CPUs can be configured to operate in conjunction with a chipset 1206. The processor(s) 1204 can be standard programmable CPUs that perform arithmetic and logical operations necessary for the operation of the device 1200.

In a variety of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a Random-Access Memory (RAM) 1208, which can be utilized as the main memory in the device 1200 in some embodiments. The chipset 1206 can further be configured to provide an interface to a computer-readable storage medium such as a Read-Only Memory (ROM) 1210 or a Non-Volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the network 1240 (shown as “LAN 1240”). The chipset 1206 can include functionality for providing network connectivity through a Network Interface Controller (NIC) 1212, which may include a gigabit Ethernet adapter or similar component. The NIC 1212 can be capable of connecting the device 1200 to other devices over the network 1240. It is contemplated that multiple NICs 1212 may be present in the device 1200, connecting the device 1200 to other types of networks and remote systems.

In more embodiments, the device 1200 can be connected to a storage 1218 that provides non-volatile storage for data accessible by the device 1200. The storage 1218 can, for example, store an operating system 1220, applications or programs 1222, network log data 1228, diagnostic context data 1230, and prompt data 1232, which are described in greater detail below. The storage 1218 can be connected to the environment 1202 through a storage controller 1214 connected to the chipset 1206. In additional embodiments, the storage 1218 can include one or more physical storage units. The storage controller 1214 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1200 can store data within the storage 1218 by transforming the physical state of the physical storage units to reflect the information being stored. The specific transformation of the physical state can depend on various factors. Examples of such factors can include, but are not limited to, the technology utilized to implement the physical storage units, whether the storage 1218 is characterized as primary or secondary storage, and the like. For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to the device 1200. Stated otherwise, some or all of the operations performed by the cloud computing network, and or any components included therein, may be performed by the device 1200 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1218 can store an operating system 1220 utilized to control the operation of the device 1200. According to one embodiment, the operating system 1220 includes the LINUX operating system. According to another embodiment, the operating system 1220 includes the Windows® server operating system from Microsoft Corporation of Redmond, Washington. According to further embodiments, the operating system 1220 can include the UNIX operating system or one of its variants. It should be appreciated that other operating systems can also be utilized. The storage 1218 can store other system or application programs and data utilized by the device 1200.

In still more embodiments, the storage 1218 or other computer-readable storage media is encoded with computer-executable instructions which, when loaded into the device 1200, may transform the device 1200 from a general-purpose computing system into a special-purpose computer capable of implementing the embodiments described herein. These computer-executable instructions may be stored as applications or programs 1222 and transform the device 1200 by specifying how the processor(s) 1204 can transition between states, as described above. In still further embodiments, the device 1200 has access to computer-readable storage media storing computer-executable instructions which, when executed by the device 1200, perform the various processes described above with regard to FIGS. 1-11. In still additional embodiments, the device 1200 can also include computer-readable storage media having instructions stored thereupon for performing any of the other computer-implemented operations described herein.

In some more embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 may not include all of the components shown in FIG. 12, and can include other components that are not explicitly shown in FIG. 12, or may utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In yet various embodiments, the device 1200 can include a network diagnostics logic 1224 that may be responsible for context-aware, AI-driven network diagnostics and troubleshooting. In yet more embodiments, the network diagnostics logic 1224 may operate in an automation system. In embodiments where the device 1200 corresponds to the automation system, the network diagnostics logic 1224 can be configured to perform various operations such as, but not limited to, receiving a user input indicative of an issue associated with the network, wherein the user input comprises a plurality of first logs associated with a plurality of network devices in the network; deriving at least one diagnostic context based on the user input; determining a network topology from the diagnostic context(s); extracting network log data from a plurality of second logs based on at least one of the user input, the network topology, or configurable criteria; identifying, from the extracted network log data, a root cause of the issue; and generating at least one recommendation based on the root cause to address the issue. In still yet more embodiments where the device 1200 corresponds to the automation system, the network diagnostics logic 1224 can be configured to perform various operations such as, but not limited to, receiving a user input indicative of an issue associated with the network, wherein the user input comprises a plurality of logs associated with a plurality of network devices in the network; running the user input through a filter pipeline; deriving at least one diagnostic context associated with the issue from an output of the filter pipeline; augmenting a prompt template based on the at least one diagnostic context; identifying a root cause of the issue based on the augmented prompt template; and generating at least one recommendation based on the root cause to address the issue.

Those skilled in the art will recognize that the network diagnostics logic 1224 can include various hardware and/or software deployments and can be configured in a variety of ways. In many additional embodiments, the network diagnostics logic 1224 can be configured as a standalone device, exist as a logic in another network device, be distributed among various network devices operating in tandem, or remotely operated as part of a cloud-based network management tool. In still yet further embodiments, one or more servers can be configured with the network diagnostics logic 1224 or can otherwise operate as the network diagnostics logic 1224. In still yet additional embodiments, the network diagnostics logic 1224 may operate on one or more servers connected to a communication network, for example, the Internet. The communication network can include wired networks or wireless networks. The network diagnostics logic 1224 can be provided as a cloud-based service that can service remote networks, such as, but not limited to, a deployed network. Further, in several embodiments, the network diagnostics logic 1224 may be operated as a distributed logic across multiple network devices. In an embodiment, the controller can operate as the network diagnostics logic 1224 or may have multiple devices operate as the network diagnostics logic 1224 in a distributed manner.

In several more embodiments, the storage 1218 can include network log data 1228. The network log data 1228 may relate to data representative of logs including various events, activities, and transactions occurring within the network. The network log data 1228 may include detailed information or data about every network device, link, network event or activity, network traffic, application data, system-level event, interaction, transaction, network traffic including data packets, connection attempts, bandwidth usage, or the like, in the network. The network log data 1228 may include, for example, a timestamp such as a date and a time when an event or activity occurred, device information such as device identifier, type of device, or the like, IP addresses, ports, MAC addresses, event type, protocol utilized such as Transmission Control Protocol (TCP), User Datagram Protocol (UDP), HTTP, File Transfer Protocol (FTP), or the like, event status, payload, or the like. The network log data may be extracted from the logs based on the user input, the network topology, or configurable criteria including a time range or an indication regarding one or more subsystems within network devices in the network, to identify a root cause of an issue associated with the network.

In further additional embodiments, the storage 1218 can include diagnostic context data 1230. The diagnostic context data 1230 may relate to data representative of a context for diagnosing the issue associated with the network. In some more embodiments, the diagnostic context data 1230 may include intent, insights, and the context derived from the user input indicative of the issue. The diagnostic context data 1230 may further include, for example, CLI commands associated with the issue, log extracts, user-provided descriptions and symptoms of the issue, diagnostic workflows, findings, or the like. The diagnostic context data 1230 may be reusable for training a machine learning model, for example, an LLM, which may also help improve future diagnostics, collaborative learning, and knowledge sharing across teams.

In many embodiments, the storage 1218 can include prompt data 1232. The prompt data 1232 may relate to data representative of prompts that may be represented as signatures of individual issues. The prompt data may be stored as a graph in a prompt database. The prompt data may include, for example, user-provided context such as interface-specific logs, extracted logs from a specified time range including spanning-tree error messages, driver faults, control plane, or the like, preprocessed bug signatures relevant to interface error-disabled issues, topology-specific insights, and data from a vector database for the current log extracts. The prompt data may further include, for example, diagnostic domains and subdomains associated with the issue, for example, drop class, forwarding issues, buffer stuck, or the like. The prompt data may be utilized to prompt the LLM, which may augment the LLM's context, providing the LLM with a more comprehensive understanding of the issue. This augmented context may allow the LLM to generate more precise, informative, and engaging responses to a user's queries.

In a number of embodiments, data may be processed into a format usable by an ML model(s) 1226 (e.g., feature vectors), and/or other pre-processing techniques. The ML model(s) 1226 may be any type of ML model(s), such as supervised models, reinforcement models, and/or unsupervised models. The ML model(s) 1226 may include one or more of linear regression models, logistic regression models, decision trees, Naïve Bayes models, neural networks, k-means cluster models, random forest models, and/or other types of ML models. The ML model(s) may include an LLM, an LAM, or the like. In a variety of embodiments, the ML model(s) 1226 may be configured to analyze the logs for deriving the diagnostic context data 1230 based on the user input. In various embodiments, the ML model(s) 1226 may be configured to analyze the diagnostic context data 1230 and the prompt data 1232 to extract relevant network log data and enhance responses to the user's queries. In more embodiments, the ML model(s) 1226 may be configured to analyze the extracted network log data to identify the root cause of the issue therefrom.

Although a specific embodiment for a device 1200 suitable for configuration with the network diagnostics logic 1224 for carrying out the various steps, processes, methods, and operations described herein is discussed with respect to FIG. 12, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the network diagnostics logic 1224 acts in tandem between the devices. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
one or more processors;
a network interface controller configured to provide access to a network; and
a memory communicatively coupled to the one or more processors, wherein the memory comprises a network diagnostics logic configured to:
receive a user input indicative of an issue associated with the network, wherein the user input comprises a plurality of first logs associated with a plurality of network devices in the network;
derive at least one diagnostic context based on the user input;
determine a network topology from the at least one diagnostic context;
extract network log data from a plurality of second logs based on at least one of the user input, the network topology, or configurable criteria;
identify, from the extracted network log data, a root cause of the issue; and
generate at least one recommendation based on the root cause to address the issue.

2. The device of claim 1, wherein the user input further comprises at least one of: a description of the issue, an indication regarding one or more subsystems within each of the plurality of network devices, a time range, or one or more topology-specific filter criteria.

3. The device of claim 1, wherein the configurable criteria comprise at least one of: a time range configured to target a period when the issue occurred, or an indication regarding one or more subsystems within the plurality of network devices.

4. The device of claim 3, wherein the network diagnostics logic is further configured to automatically determine the time range to extract the network log data from the plurality of second logs, based on the user input and one or more event correlations in the plurality of first logs.

5. The device of claim 1, wherein the network diagnostics logic is further configured to store the extracted network log data in a vector database.

6. The device of claim 1, wherein the network diagnostics logic is further configured to store the user input, the at least one diagnostic context, and the extracted network log data in a context database.

7. The device of claim 6, wherein the context database is configured as a reusable knowledge base to provide automated diagnostics for one or more subsequent issues.

8. The device of claim 1, wherein the network diagnostics logic is further configured to execute a machine learning model to identify the root cause of the issue.

9. The device of claim 8, wherein the machine learning model is a large language model.

10. The device of claim 8, wherein the network diagnostics logic is further configured to:
generate one or more prompts for the machine learning model based on at least one of: the user input, the extracted network log data, the network topology, one or more pre-processed bug signatures associated with the issue, or a vector database associated with the extracted network log data; and
input the one or more prompts to the machine learning model, wherein the root cause of the issue is identified based on an output of the machine learning model for the one or more prompts.

11. The device of claim 1, wherein the at least one diagnostic context comprises one or more command line interface commands associated with the issue, the extracted network log data, and the user input.

12. The device of claim 1, wherein the issue is a previously unclassified issue.

13. The device of claim 1, wherein the at least one recommendation corresponds to one of a bug match for the issue or at least one summary associated with the issue.

14. The device of claim 1, wherein the network diagnostics logic is further configured to:
render a conversational interface for receiving one or more queries associated with the plurality of second logs;
translate the received one or more queries into at least one command corresponding to the network; and
extract the network log data from the plurality of second logs further based on the at least one command.

15. The device of claim 1, wherein the network diagnostics logic is further configured to:
select a natural language processing parser based on one or more formats associated with the plurality of first logs; and
parse the plurality of first logs based on the selected natural language processing parser, wherein the at least one diagnostic context is derived based on the parsed plurality of first logs.

16. A device, comprising:
one or more processors;
a network interface controller configured to provide access to a network; and
a memory communicatively coupled to the one or more processors, wherein the memory comprises a network diagnostics logic configured to:
receive a user input indicative of an issue associated with the network, wherein the user input comprises a plurality of logs associated with a plurality of network devices in the network;
run the user input through a filter pipeline;
derive at least one diagnostic context associated with the issue from an output of the filter pipeline;
augment a prompt template based on the at least one diagnostic context;
identify a root cause of the issue based on the augmented prompt template; and
generate at least one recommendation based on the root cause to address the issue.

17. The device of claim 16, wherein the issue is a previously classified issue.

18. The device of claim 16, wherein the at least one diagnostic context comprises a network topology, network log data, a time range, or one or more topology-specific filter criteria associated with the issue.

19. The device of claim 16, wherein the network diagnostics logic is further configured to input the augmented prompt template to a machine learning model, and wherein the root cause of the issue is identified based on an output of the machine learning model.

20. A method, comprising:
receiving a user input indicative of an issue associated with a network, wherein the user input comprises a plurality of first logs associated with a plurality of network devices in the network;
deriving at least one diagnostic context based on the user input;
determining a network topology from the at least one diagnostic context;
extracting network log data from a plurality of second logs based on at least one of the user input, the network topology, or configurable criteria;
identifying, from the extracted network log data, a root cause of the issue; and
generating at least one recommendation based on the root cause to address the issue.
